(19) United States
(12) Patent Application Publication
(10) Pub. No.: US 2025/0392975 A1
(43) Pub. Date: Dec. 25, 2025

(54) TERMINAL DEVICE, INFORMATION PROCESSING DEVICE, AND COMMUNICATION METHOD

(71) Applicant: SONY GROUP CORPORATION, Tokyo (JP)

(72) Inventors: Toshiya IKENAGA, Tokyo (JP); Jungo GOTO, Tokyo (JP)

(21) Appl. No.: 18/881,318

(22) PCT Filed: Jun. 12, 2023
(86) PCT No.: PCT/JP2023/021661

§ 371 Date: Jan. 6, 2025

(30) Foreign Application Priority Data
Jul. 21, 2022 (JP) 2022-116095

(51) Int. Cl. H04W 40/12; H04W 8/18

(52) U.S. Cl. CPC H04W 40/12; H04W 8/18

(57) ABSTRACT

A terminal device is a terminal device capable of performing simultaneous communication simultaneously using a plurality of communication paths associated with different SIMs, respectively, the terminal device including a communication control unit that performs communication using a mode when the terminal device performs the simultaneous communication or one communication path out of the plurality of communication paths determined on the basis of information regarding the communication, in which the information regarding the communication includes information on radio quality between the terminal device and a base station for each of the communication paths, information on a congestion degree of a network for each of the communication paths, and information on service quality for each of the communication paths.

### FIELD

The present disclosure relates to a terminal device, an information processing device, and a communication method.

### BACKGROUND

A mobile network (for example, a cellular network such as 5G) is actively used. For example, in recent years, a mobile network has been used for streaming distribution.

### CITATION LIST

### Patent Literature

Patent Literature 1: JP 2020-136961 A

### SUMMARY

### Technical Problem

In communication services such as streaming distribution, a mobile network is required to have high communication performance (for example, stable communication quality, low delay, high reliability, high throughput or the like). However, in the conventional radio communication technology, the communication performance as high as that required by the communication service is not always implemented. For example, in a case where live streaming of business broadcasting such as television broadcasting is performed via the mobile network, communication quality might become unstable due to a radio environment that changes from moment to moment, a congestion situation of a base station or the like. In this case, a video viewing experience of a user is impaired due to a primary stop of a streaming video, disturbance of the video or the like.

Therefore, the present disclosure proposes a terminal device, an information processing device, and a communication method capable of implementing communication with high communication performance.

Note that, the above problem or object is merely one of a plurality of problems or objects that can be solved or achieved by a plurality of embodiments disclosed in the present specification.

### Solution to Problem

In order to solve the above problem, a terminal device according to one aspect of the present disclosure capable of performing simultaneous communication simultaneously using a plurality of communication paths associated with different SIMs, respectively, the terminal device includes: a communication control unit that performs communication using a mode when the terminal device performs the simultaneous communication or one communication path out of the plurality of communication paths determined on a basis of information regarding the communication, wherein the information regarding the communication includes information on radio quality between the terminal device and a base station for each of the communication paths, information on a congestion degree of a network for each of the communication paths, and information on service quality for each of the communication paths.

### BRIEF DESCRIPTION OF DRAWINGS

FIG. 1 is a diagram for illustrating an outline of a communication system of the present embodiment.

FIG. 2 is a flowchart illustrating an outline of an operation of the communication system of the present embodiment.

FIG. 3 is a diagram illustrating a configuration example of a communication system 1 according to an embodiment of the present disclosure.

FIG. 4 is a diagram illustrating a configuration example of the communication system 1 in a case where one of networks is a cellular network.

FIG. 5 is a diagram illustrating a configuration example of a server 10 according to the embodiment of the present disclosure.

FIG. 6 is a diagram illustrating a configuration example of a management device 20 according to the embodiment of the present disclosure.

FIG. 7 is a diagram illustrating a configuration example of a base station 30 according to the embodiment of the present disclosure.

FIG. 8 is a diagram illustrating a configuration example of a terminal device 40 according to the embodiment of the present disclosure.

FIG. 9 is a diagram for illustrating a first communication mode.

FIG. 10 is a diagram for illustrating the first communication mode.

FIG. 11 is a diagram for illustrating a second communication mode.

FIG. 12 is a diagram for illustrating the second communication mode.

FIG. 13 is a diagram for illustrating a third communication mode.

FIG. 14 is a flowchart illustrating communication control processing of the first embodiment.

FIG. 15 is a sequence diagram illustrating the communication control processing of the first embodiment.

FIG. 16 is a flowchart illustrating communication control processing of a second embodiment.

FIG. 17 is a flowchart illustrating communication path selection processing of a third embodiment.

### DESCRIPTION OF EMBODIMENTS

Hereinafter, embodiments of the present disclosure are described in detail with reference to the drawings. Note that, in the following embodiments, the same parts are denoted by the same reference signs, and redundant description is omitted.

In the present specification and the drawings, a plurality of components having substantially similar functional configuration might be distinguished by attaching different numbers after the same reference sign. For example, a plurality of configurations having substantially the same functional configuration is distinguished as terminal devices 40₁, 40₂, and 40₃ as necessary. However, in a case where it is not particularly necessary to distinguish each of a plurality of components having substantially the same functional configuration, only the same reference numeral is attached. For example, in a case where it is not necessary to particularly distinguish the terminal devices 40₁, 40₂, and 40₃, they are simply referred to as terminal devices 40.

One or a plurality of embodiments (including examples and variations) described below can each be implemented independently. In contrast, at least a part of a plurality of embodiments described below may be appropriately implemented in combination with at least a part of other embodiments. The plurality of embodiments may include novel features different from each other. Therefore, the plurality of embodiments can contribute to solving different objects or problems, and can exhibit different effects.

### 1. Outline

When business broadcasting such as sports broadcasting is performed, high image quality and constantly stable communication quality are required. Therefore, conventionally, a method has been adopted in which a wired cable is connected to a camera for imaging and streaming is performed to a television station via a relay vehicle. However, in distribution using the wired cable, pre-wiring of the cable or restriction in camera movement due to the cable occur. Therefore, in recent years, streaming distribution by radio using a mobile network (for example, cellular network such as 5G) has been studied.

However, the use of the mobile network for a communication service such as the streaming distribution has a problem that communication performance is deteriorated due to, for example, following causes (1) to (3).
(1) Deterioration in radio environment (for example, shielding object, cell edge or the like)
(2) Reduction in allocation of communication band due to increase in traffic of other terminal devices connected to base station
(3) Lack of follow to rapid change in communication traffic of communication service by network side resource allocation

It is difficult to cope with these changes only with information held by a terminal device (or a server that provides the communication service). Therefore, in the conventional technology, the communication performance as high as that required by the communication service is not necessarily implemented.

Therefore, the present embodiment solves the above-described problem as follows.

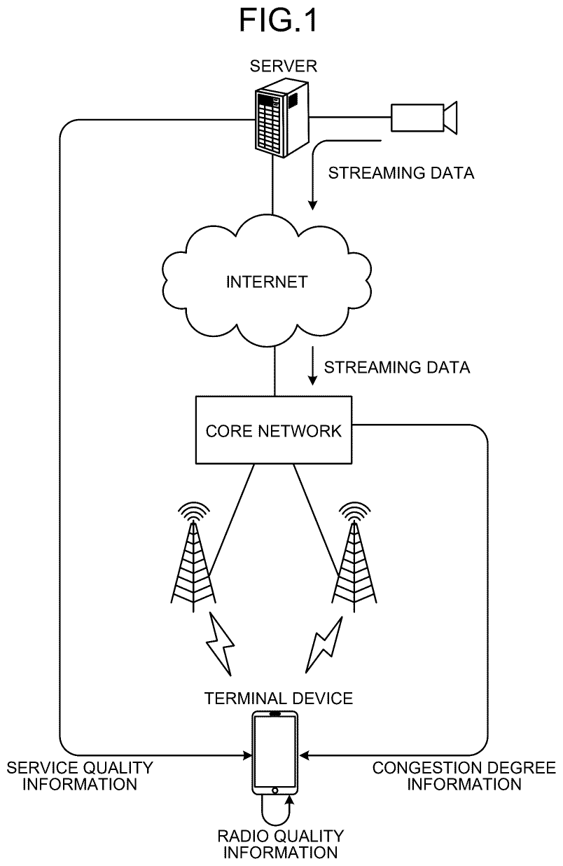

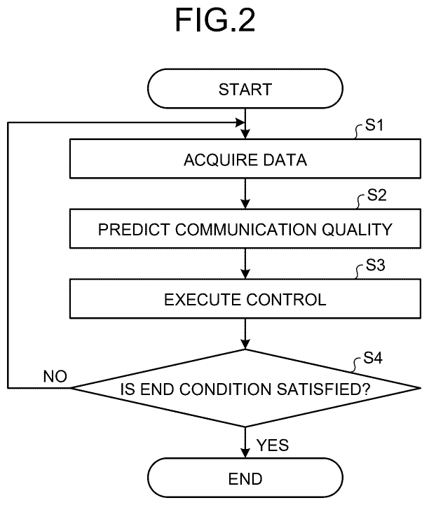

FIGS. 1 and 2 are diagrams for illustrating an outline of the present embodiment. Specifically, FIG. 1 is a diagram for illustrating an outline of a communication system of the present embodiment, and FIG. 2 is a flowchart illustrating an outline of an operation of the communication system of the present embodiment.

In an example of FIG. 1, the communication system is provided with a server that provides a streaming service and a terminal device that receives the streaming service from the server. The server and the terminal device are connected to each other via one or a plurality of core networks forming a cellular network, and the Internet. Note that, in the example of FIG. 1, streaming data is transmitted from the server to the terminal device, but the streaming data may be transmitted from the terminal device to the server. The terminal device may be capable of performing communication (hereinafter, also referred to as simultaneous communication) using a plurality of communication paths (bearers) simultaneously. At that time, a plurality of communication paths may be associated with different subscriber identity modules (SIMs).

Hereinafter, the outline of the operation of the communication system is described with reference to the flowchart of FIG. 2. Processing (hereinafter, referred to as communication control processing) illustrated in FIG. 2 may be executed by the terminal device or may be executed by the server. In the following description, as an example, it is assumed that the terminal device executes the communication control processing.

First, the terminal device acquires information regarding the communication from each entity forming the communication system. For example, the terminal device acquires the information regarding the communication from the server, the core network, and the terminal device itself (step S1). The information regarding the communication includes, for example, information on radio quality between the terminal device and a base station for each communication path, information on a congestion degree of the network for each communication path, and information on service quality for each communication path. The terminal device may acquire these pieces of information from each entity in real time.

Subsequently, the terminal device predicts communication quality of each of a plurality of communication paths on the basis of the information regarding the communication (step S2). The terminal device executes control of the streaming service (for example, setting control regarding the streaming service) on the basis of a prediction result (step S3).

For example, the terminal device determines one communication path out of a plurality of communication paths on the basis of the prediction result of the communication quality. Alternatively, the terminal device determines a mode used when the terminal device performs the simultaneous communication out of a plurality of modes on the basis of the prediction result of the communication quality. At that time, a plurality of modes selectable by the terminal device may include a redundant communication mode (first mode) in which the same packet is transmitted to a plurality of communication paths, and a high-speed communication mode (second mode) in which different packets are transmitted to a plurality of communication paths. The terminal device executes the control of the setting regarding the streaming service on the basis of the determination. For example, the terminal device executes control of a parameter regarding the communication quality of the terminal device and/or the server.

Subsequently, the terminal device discriminates whether the streaming service satisfies an end condition (step S4). In a case where the end condition is not satisfied (step S4: No), the terminal device returns the processing to step S1. In a case where the end condition is satisfied (step S4: Yes), the terminal device ends the communication control processing.

According to the present embodiment, since the communication system predicts the quality of the communication path on the basis of the information collected from a plurality of entities, this can predict the quality of each communication path with high accuracy. Since the communication system controls the communication on the basis of a prediction result, stable and high-quality streaming can be implemented.

The outline of the present embodiment is described above, and a communication system 1 according to the present embodiment is described in detail below.

### 2. Configuration of Communication System

First, a configuration of the communication system 1 is described.

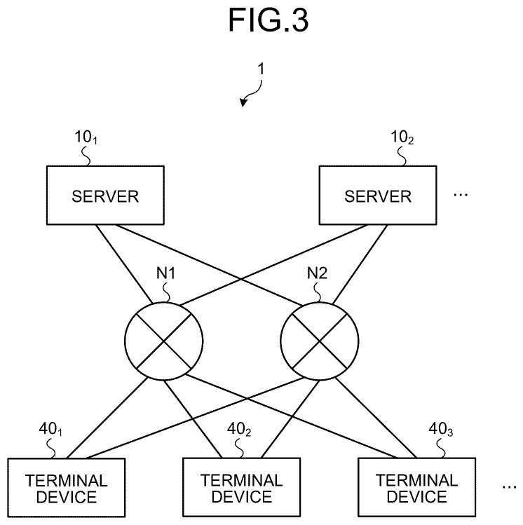

FIG. 3 is a diagram illustrating a configuration example of the communication system 1 according to the embodiment of the present disclosure. The communication system 1 includes a server 10 and a terminal device 40. The communication system 1 may include a plurality of servers 10 and a plurality of terminal devices 40. In an example of FIG. 3, the communication system 1 includes servers 10₁, 10₂ and the like as the servers 10, and includes terminal devices 40₁, 40₂, 40₃ and the like as the terminal devices 40. The terminal device 40 may be connectable to a plurality of networks. In the example of FIG. 3, the terminal device 40 is connectable to a network N1 and a network N2. The terminal device 40 is connected to the server 10 via the network N1 or N2.

The networks N1 and N2 are, for example, communication networks such as a local area network (LAN), a wide area network (WAN), a cellular network, a fixed telephone network, a regional Internet protocol (IP) network, and the Internet. The networks N1 and N2 may include a wired network or a radio network. The networks N1 and N2 may include the core network. The core network is, for example, evolved packet core (EPC) or a 5G core network (5GC). It goes without saying that the network N may be a data network connected to the core network. The data network may be a service network of a telecommunications carrier, for example, an IP multimedia subsystem (IMS) network. The data network may be a private network such as an intra-company network.

Note that, although only two networks are illustrated in the example of FIG. 3, the number of networks is not limited to two. For example, the network to which the terminal device 40 is connectable may be a plurality of cellular networks of different communication carriers and a wireless LAN network (for example, Wi-Fi (registered trademark)). It goes without saying that one network is sufficient.

The terminal device 40 may be connectable to the network using one communication path or may be connectable to the network using a plurality of communication paths. At that time, at least one of one or a plurality of communication paths may be a radio communication path. For example, the communication path may be the radio communication path (radio access network) between the terminal device 40 and the base station. The communication path may be the radio communication path between the terminal device 40 and an access point. It goes without saying that a plurality of communication paths may include a wired communication path (for example, a wired LAN). Note that, the communication path may be the network itself.

In a case where the radio communication path is included in one or a plurality of communication paths, the terminal device 40 may be configured to connect to the network using a radio access technology (RAT) such as long term evolution (LTE), new radio (NR), Wi-Fi, or Bluetooth (registered trademark). At that time, the terminal device 40 may be capable of use different radio access technologies (radio communication systems). For example, the terminal device 40 may be capable of use NR and Wi-Fi. The terminal device 40 may be capable of use different cellular communication technologies (for example, LTE and NR). LTE and NR are types of the cellular communication technology, and enables mobile communication of the terminal device by arranging a plurality of areas covered by the base station in a cellular manner.

Note that, in the following description, “LTE” includes LTE-Advanced (LTE-A), LTE-Advanced Pro (LTE-A Pro), and evolved universal terrestrial radio access (EUTRA). NR includes new radio access technology (NRAT) and Further EUTRA (FEUTRA). Note that, a single base station may manage a plurality of cells. In the following description, a cell supporting LTE is referred to as an LTE cell, and a cell supporting NR is referred to as an NR cell.

NR is a radio access technology of a next generation (fifth generation) of LTE (fourth generation communication including LTE-Advanced and LTE-Advanced Pro). NR is the radio access technology that can support various use cases including enhanced mobile broadband (eMBB), massive machine type communications (mMTC), and ultra-reliable and low latency communications (URLLC). NR has been studied aiming at a technical framework supporting usage scenarios, requirement conditions, arrangement scenarios and the like in these use cases.

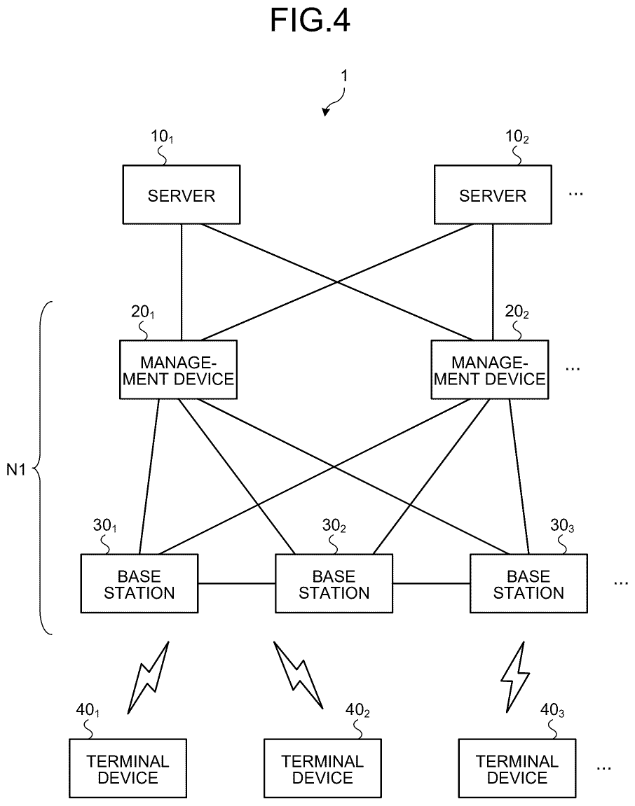

FIG. 4 is a diagram illustrating a configuration example of the communication system 1 in a case where one of the networks is the cellular network. In the example of FIG. 4, the network N1 is the cellular network. The communication system 1 is provided with the server 10, a management device 20, a base station 30, and the terminal device 40. The communication system 1 illustrated in FIG. 4 provides a user with a radio network capable of performing mobile communication by the respective radio communication devices forming the communication system 1 operating in cooperation. The radio network of the present embodiment includes, for example, the radio access network and the core network. Note that, in the present embodiment, the radio communication device is a device having a function of radio communication, and corresponds to the base station 30 and the terminal device 40 in the example of FIG. 4. In the following description, the radio communication device is sometimes simply referred to as a communication device.

The communication system 1 may be provided with a plurality of servers 10, a plurality of management device 20, a plurality of base stations 30, and a plurality of terminal devices 40. In the example of FIG. 4, the communication system 1 is provided with servers 10₁, 10₂ and the like as the servers 10, and is provided with management devices 20₁, 20₂ and the like as the management devices 20. The communication system 1 is provided with base stations 30₁, 30₂ and the like as the base stations 30, and is provided with terminal devices 40₁, 40₂, 40₃ and the like as the terminal devices 40.

Note that, the base station 30 forming the communication system 1 may be a ground station or a non-ground station. The non-ground station may be a satellite station or an aircraft station. When the non-ground station is the satellite station, the communication system 1 may be a bent-pipe (transparent) type mobile satellite communication system.

Note that, in the present embodiment, the ground station (also referred to as a ground base station) refers to a base station (including relay station) installed on the ground. Herein, “ground” is the ground in a broad sense including not only land but also underground, water surface, and underwater. Note that, in the following description, the description of “ground station” may be replaced with “gateway”.

Note that, an LTE base station is sometimes referred to as evolved node B (eNodeB) or eNB. An NR base station is sometimes referred to as gNodeB or gNB. In LTE and NR, a terminal device (also referred to as a mobile station or a terminal) is sometimes referred to as user equipment (UE). Note that, the terminal device 40 is a type of the communication device, and is also referred to as a mobile station or a terminal.

Note that, the terminal device 40 may be connectable to the network using a radio access technology (radio communication system) other than LTE, NR, Wi-Fi, and Bluetooth. For example, the terminal device 40 may be connectable to the network by using low power wide area (LPWA) communication. The terminal device 40 may be connectable to the network using radio communication of its own standard.

Herein, the LPWA communication is radio communication that enables low-power wide-range communication. For example, the LPWA radio is Internet of things (IoT) radio communication using specific low-power radio (for example, 920 MHz band) or an industry-science-medical (ISM) band. Note that, the LPWA communication used by the terminal device 40 may conform to the LPWA standard. Examples of the LPWA standard include ELTRES, ZETA, SIGFOX, LoRaWAN, NB-Iot and the like, for example. It goes without saying that the LPWA standard is not limited thereto, and may be other LPWA standards.

Note that, one or a plurality of communication paths may include a virtual network. For example, a plurality of communication paths to which the terminal device 40 is connectable may include a virtual network such as a virtual local area network (VLAN) and a physical network such as an IP communication path. In this case, the terminal device 40 may perform route control on the basis of a route control protocol such as Open Shortest Path First (OSPF) or Border Gateway Protocol (BGP).

In addition, a plurality of communication paths may include one or a plurality of overlay networks or one or a plurality of network slicings.

Note that, the devices in the drawings may be considered as devices in a logical sense. That is, a part or all of the devices in the drawings may be implemented by a virtual machine (VM), a container, a docker or the like, and they may be implemented on physically the same hardware.

Hereinafter, a configuration of each device forming the communication system 1 is specifically described. Note that, the configuration of each device described below is merely an example. The configuration of each device may be different from the following configuration.

### <2-1. Configuration of Server>

First, a configuration of the server 10 is described.

The server 10 is an information processing device (computer) that provides various services to the terminal device 40 via the network (for example, the networks N1 and N2). For example, the server 10 is the server that provides the streaming service. The streaming service may be an upload service for transmitting the streaming data from the terminal device 40 to the server 10, or may be a download service (distribution service) for transmitting the streaming data from the server 10 to the terminal device 40.

Note that, the server 10 is not limited to the above-described server. For example, the server 10 may be an application server or a web server. The server 10 may be a PC server, a midrange server, or a mainframe server. The server 10 may be an information processing device that performs data processing (edge processing) near the user or the terminal. For example, the server 10 may be an information processing device (computer) provided side by side with or built in the base station. It goes without saying that the server 10 may be an information processing device that performs cloud computing.

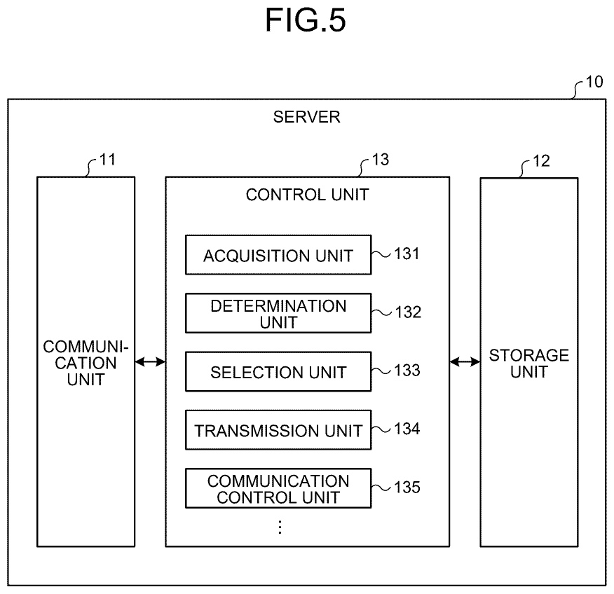

FIG. 5 is a diagram illustrating a configuration example of the server 10 according to the embodiment of the present disclosure. The server 10 is provided with a communication unit 11, a storage unit 12, and a control unit 13. Note that, the configuration illustrated in FIG. 5 is a functional configuration, and a hardware configuration may be different from this. The functions of the server 10 may be implemented in a distributed manner in a plurality of physically separated configurations. For example, the server 10 may include a plurality of information processing devices.

The communication unit 11 is a communication interface for communicating with other devices. For example, the communication unit 11 is a network interface. For example, the communication unit 11 is a local area network (LAN) interface such as a network interface card (NIC). Note that, the communication unit 11 may be a wired interface or a radio interface. The communication unit 11 functions as a communication means of the server 10. The communication unit 11 communicates with the terminal device 40 under control of the control unit 13.

The storage unit 12 is a data readable/writable storage device such as a dynamic random access memory (DRAM), a static random access memory (SRAM), a flash memory or a hard disk. The storage unit 12 functions as a storage means of the server 10. The storage unit 12 stores a prediction model (learning model) for predicting the quality of the communication path.

The control unit 13 is a controller that controls each unit of the server 10. The control unit 13 is implemented by, for example, a processor such as a central processing unit (CPU) and a micro processing unit (MPU). For example, the control unit 13 is implemented by a processor executing various programs stored in a storage device in the server 10 using a random access memory (RAM) or the like as a work area. Note that, the control unit 13 may be implemented by an integrated circuit such as an application specific integrated circuit (ASIC) and a field programmable gate array (FPGA). Any of the CPU, MPU, ASIC, and FPGA can be regarded as a controller.

As illustrated in FIG. 5, the control unit 13 is provided with an acquisition unit 131, a determination unit 132, a selection unit 133, a transmission unit 134, and a communication control unit 135. Each block (acquisition unit 131 to communication control unit 135) forming the control unit 13 is a functional block indicating a function of the control unit 13. These functional blocks may be software blocks or hardware blocks. For example, each of the functional blocks described above may be one software module implemented by software (including microprogram), or may be one circuit block on a semiconductor chip (die). It goes without saying that each functional block may be one processor or one integrated circuit. A configuration method of the functional block is optional. Note that, the control unit 13 may be configured by a functional unit different from the above-described functional block. An operation of the control unit 13 may be the same as an operation of each block of the control unit 43 of the terminal device 40.

### <2-2. Configuration of Management Device>

Next, a configuration of the management device 20 is described.

The management device 20 is a device that manages the radio network. For example, the management device 20 is a device that manages communication of the base station 30. The management device 20 may be, for example, a device having a function as a mobility management entity (MME). The management device 20 may be a device having a function as an access and mobility management function (AMF) and/or a session management function (SMF). It goes without saying that the functions of the management device 20 are not limited to the MME, AMF, and SMF. The management device 20 may be a device having a function as a network slice selection function (NSSF), an authentication server function (AUSF), a policy control function (PCF), or a unified data management (UDM). The management device 20 may be a device having a function as a home subscriber server (HSS).

Note that, the management device 20 may have a function of the gateway. For example, the management device 20 may have a function as a serving gateway (S-GW) or a packet data network gateway (P-GW). The management device 20 may have a function as a user plane function (UPF).

The core network has a plurality of network functions, and respective network functions may be aggregated into one physical device or distributed to a plurality of physical devices. That is, the management device 20 can be arranged in a plurality of devices in a distributed manner. Moreover, this distributed arrangement may be controlled to be executed dynamically. The base station 30 and the management device 20 form one network, and provide a radio communication service to the terminal device 40. The management device 20 is connected to the Internet, and the terminal device 40 can use various services provided via the Internet via the base station 30.

Note that, the management device 20 is not necessarily a device forming the core network. For example, it is assumed that the core network is a core network of wideband code division multiple access (W-CDMA) or code division multiple access 2000 (cdma 2000). At that time, the management device 20 may be a device that functions as a radio network controller (RNC).

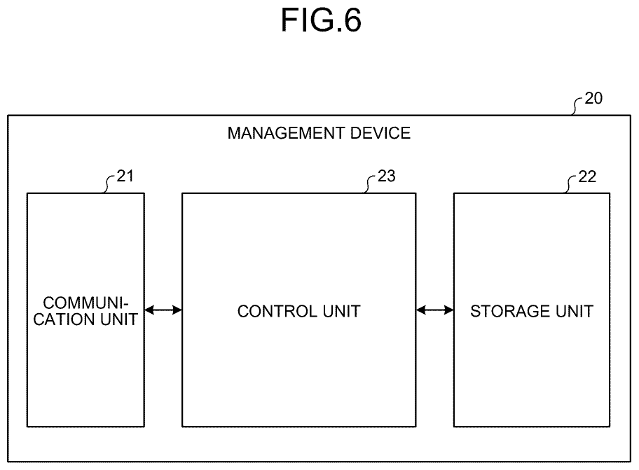

FIG. 6 is a diagram illustrating a configuration example of the management device 20 according to the embodiment of the present disclosure. The management device 20 is provided with a communication unit 21, a storage unit 22, and a control unit 23. Note that, the configuration illustrated in FIG. 6 is a functional configuration, and a hardware configuration may be different from this. The functions of the management device 20 may be statically or dynamically implemented in a distributed manner in a plurality of physically separated configurations. For example, the management device 20 may include a plurality of server devices.

The communication unit 21 is a communication interface for communicating with other devices. The communication unit 21 may be a network interface or a device connection interface. For example, the communication unit 21 may be a local area network (LAN) interface such as a network interface card (NIC), or may be a USB interface including a universal serial bus (USB) host controller, a USB port and the like. The communication unit 21 may be a wired interface or a radio interface. The communication unit 21 functions as a communication means of the management device 20. The communication unit 21 communicates with the base station 30 and the like under control of the control unit 23.

The storage unit 22 is a data readable/writable storage device such as a dynamic random access memory (DRAM), a static random access memory (SRAM), a flash memory or a hard disk. The storage unit 22 functions as a storage means of the management device 20. The storage unit 22 stores, for example, a connection state of the terminal device 40. For example, the storage unit 22 stores a state of radio resource control (RRC), EPS connection management (ECM), or 5G system connection management (CM) of the terminal device 40. The storage unit 22 may function as a home memory that stores position information of the terminal device 40.

The control unit 23 is a controller that controls each unit of the management device 20. The control unit 23 is implemented by, for example, a processor such as a central processing unit (CPU), a micro processing unit (MPU), and a graphics processing unit (GPU). For example, the control unit 23 is implemented by a processor executing various programs stored in a storage device in the management device 20 using a random access memory (RAM) or the like as a work area. Note that, the control unit 23 may be implemented by an integrated circuit such as an application specific integrated circuit (ASIC) and a field programmable gate array (FPGA). Any of the CPU, MPU, GPU, ASIC, and FPGA can be regarded as a controller.

### <2-3. Configuration of Base Station>

Next, a configuration of the base station 30 is described.

The base station 30 is a radio communication device that performs the radio communication with the terminal device 40. The base station 30 may be configured to perform the radio communication with the terminal device 40 via the relay station, or may be configured to directly perform the radio communication with the terminal device 40.

The base station 30 is a type of the communication device. More specifically, the base station 30 is a device corresponding to a radio base station (base station, Node B, eNB, gNB or the like) or a radio access point. The base station 30 may be a radio relay station. The base station 30 may be an optical extension device referred to as a remote radio head (RRH) or a radio unit (RU). The base station 30 may be a reception station such as a field pickup unit (FPU). The base station 30 may be an integrated access and backhaul (IAB) donor node or an IAB relay node that provides a radio access line and a radio backhaul line by time division multiplexing, frequency division multiplexing, or space division multiplexing.

Note that, the radio access technology used by the base station 30 may be a cellular communication technology or a wireless LAN technology. It goes without saying that the radio access technology used by the base station 30 is not limited thereto, and may be another radio access technology. For example, the radio access technology used by the base station 30 may be a low power wide area (LPWA) communication technology. It goes without saying that the radio communication used by the base station 30 may be radio communication using a quasi-millimeter wave or a millimeter wave. The radio communication used by the base station 30 may be radio communication using a radio wave or radio communication (optical radio) using an infrared ray or visible light.

The base station 30 may be capable of performing non-orthogonal multiple access (NOMA) communication with the terminal device 40. Here, the NOMA communication is communication using a non-orthogonal resource (transmission, reception, or both of them). Note that, the base station 30 may be capable of performing the NOMA communication with another base station 30.

Note that, the base stations 30 may be capable of communicating with each other via a base station-core network interface (for example, NG interface, S1 interface and the like). This interface may be either the wired or radio interface. The base stations may be capable of communicating with each other via a base station-base station interface (for example, Xn interface, X2 interface, S1 interface, F1 interface and the like). This interface may be either the wired or radio interface.

Note that, the concept of the base station includes not only the donor base station but also the relay base station (also referred to as the relay station). For example, the relay base station may be any one of an RF repeater, a smart repeater, and an intelligent surface. The concept of the base station includes not only a structure having a function of the base station but also a device installed in the structure.

The structure is, for example, a building such as a multistory building, a house, a steel tower, a station facility, an airport facility, a harbor facility, an office building, a school building, a hospital, a factory, a commercial facility, or a stadium. Note that, the concept of the structure includes not only the building but also a non-building structure such as a tunnel, a bridge, a dam, a wall, or an iron pillar, and equipment such as a crane, a gate, or a windmill. The concept of the structure includes not only a structure on the land (on the ground in a narrow sense) or an underground structure, but also a structure on water such as a platform or a megafloat, and an underwater structure such as a marine observation facility. The base station may be referred to as an information processing device.

The base station 30 may be the donor station or the relay station (relay station). The base station 30 may be a fixed station or a mobile station. The mobile station is the radio communication device (for example, the base station) configured to be movable. At that time, the base station 30 may be a device installed in a mobile body or may be the mobile body itself. For example, the relay station having mobility can be regarded as the base station 30 as the mobile station. A device that originally is a device having mobility and has a function of the base station (at least a part of the function of the base station), such as a vehicle, an unmanned aerial vehicle (UAV) represented by a drone, or a smartphone, also corresponds to the base station 30 as the mobile station.

Here, the mobile body may be a mobile terminal such as a smartphone or a mobile phone. The mobile body may be a mobile body (for example, a vehicle such as an automobile, a bicycle, a bus, a truck, a motorcycle, a train, or a linear motor car) that moves on the land (on the ground in a narrow sense) or a mobile body (for example, subway) that moves underground (for example, in the tunnel).

The mobile body may be a mobile body (for example, a ship such as a passenger ship, a cargo ship, or a hovercraft) that moves on water, or a mobile body (for example, a submarine boat such as a submersible, a submarine, and unmanned diving machine) that moves underwater.

Note that, the mobile body may be a mobile body (for example, an aircraft such as an airplane, an airship, or a drone) that moves in the atmosphere.

The base station 30 may be a ground base station (ground station) installed on the ground. For example, the base station 30 may be a base station arranged in a structure on the ground, or may be a base station installed in the mobile body moving on the ground. More specifically, the base station 30 may be an antenna installed in the structure such as the building and a signal processing device connected to the antenna. It goes without saying that the base station 30 may be the structure or the mobile body itself. The “ground” is the ground in a broad sense including not only the land (the ground in a narrow sense) but also underground, water surface, and underwater. Note that, the base station 30 is not limited to the ground base station. For example, in a case where the communication system 1 is a satellite communication system, the base station 30 may be the aircraft station. From the perspective of the satellite station, the aircraft station located on the earth is the ground station.

Note that, the base station 30 is not limited to the ground station. The base station 30 may be a non-ground base station (non-ground station) capable of floating in the air or space. For example, the base station 30 may be the aircraft station or the satellite station.

The satellite station is a satellite station capable of floating outside the atmosphere. The base station may be a device mounted on a space mobile body such as an artificial satellite or may be the space mobile body itself. The space mobile body is a mobile body that moves outside the atmosphere. Examples of the space mobile body include artificial celestial bodies such as the artificial satellite, a spacecraft, a space station, and a probe.

Note that, the satellite serving as the satellite station may be any of a low earth orbiting (LEO) satellite, a medium earth orbiting (MEO) satellite, a geostationary earth orbiting (GEO) satellite, and a highly elliptical orbiting (HEO) satellite. It goes without saying that the satellite station may be a device mounted on the low earth orbiting satellite, medium earth orbiting satellite, geostationary earth orbiting satellite, or high elliptical orbiting satellite.

The aircraft station is the radio communication device capable of floating in the atmosphere, such as the aircraft. The aircraft station may be a device mounted on the aircraft or the like, or may be the aircraft itself. Note that, the concept of the aircraft includes not only a heavy aircraft such as an airplane and a glider but also a light aircraft such as a balloon and an airship. The concept of the aircraft includes not only the heavy aircraft and light aircraft but also a rotary wing aircraft such as a helicopter and an autogiro. Note that, the aircraft station (alternatively, an aircraft on which the aircraft station is mounted) may be an unmanned aircraft such as the drone.

Note that, the concept of the unmanned aircraft also includes unmanned aircraft systems (UAS) and a tethered UAS. The concept of the unmanned aircraft also includes a lighter than air UAS (LTA) and a heavier than air UAS (HTA). Other concepts of the unmanned aircraft also include high altitude UAS platforms (HAPs).

Coverage of the base station 30 may be as large as a macro cell and as small as a pico cell. It goes without saying that the coverage of the base station 30 may be extremely small such as a femto cell. The base station 30 may have a beamforming capability. In this case, in the base station 30, a cell or a service area may be formed for each beam.

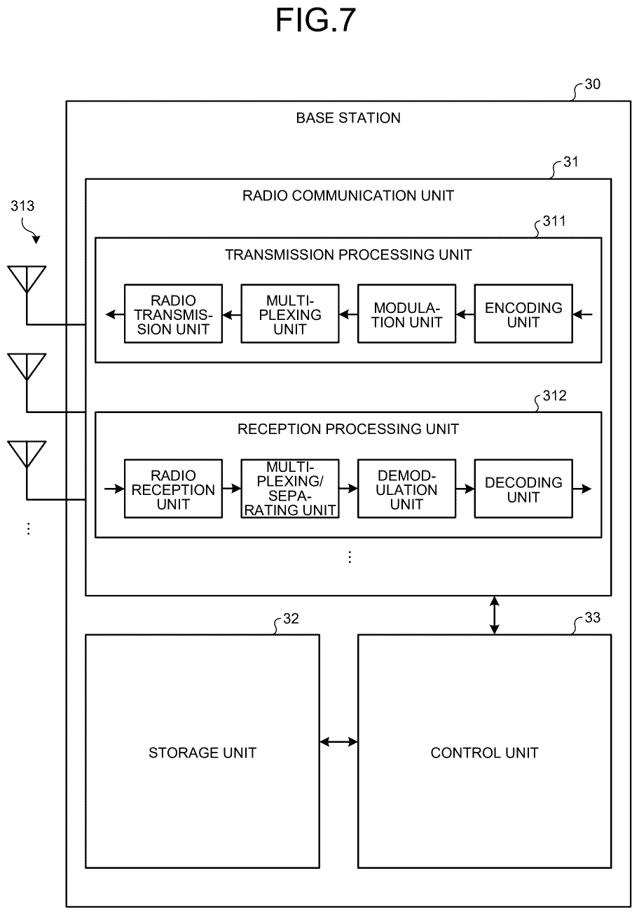

FIG. 7 is a diagram illustrating a configuration example of the base station 30 according to the embodiment of the present disclosure. The base station 30 is provided with a radio communication unit 31, a storage unit 32, and a control unit 33. Note that, the configuration illustrated in FIG. 7 is a functional configuration, and a hardware configuration may be different from this. The functions of the base station 30 may be implemented in a distributed manner in a plurality of physically separated configurations.

The radio communication unit 31 is a signal processing unit for performing the radio communication with other radio communication devices (for example, the terminal device 40). The radio communication unit 31 operates under control of the control unit 33. The radio communication unit 31 supports one or a plurality of radio access systems. For example, the radio communication unit 31 supports both NR and LTE. The radio communication unit 31 may support W-CDMA or cdma2000 in addition to NR or LTE. The radio communication unit 31 may support an automatic retransmission technology such as hybrid automatic repeat request (HARQ).

The radio communication unit 31 is provided with a transmission processing unit 311, a reception processing unit 312, and an antenna 313. The radio communication unit 31 may be provided with a plurality of transmission processing units 311, a plurality of reception processing units 312, and a plurality of antennas 313. Note that, in a case where the radio communication unit 31 supports a plurality of radio access systems, each unit of the radio communication unit 31 can be configured individually for each radio access system. For example, the transmission processing unit 311 and the reception processing unit 312 may be individually configured by LTE and NR. The antenna 313 may include a plurality of antenna elements (for example, a plurality of patch antennas). In this case, the radio communication unit 31 may be configured to be able to perform beamforming. The radio communication unit 31 may be configured to be able to perform polarization beamforming using a vertically polarized wave (V polarized wave) and a horizontally polarized wave (H polarized wave).

The transmission processing unit 311 performs transmission processing of downlink control information and downlink data. For example, the transmission processing unit 311 encodes the downlink control information and the downlink data input from the control unit 33 using an encoding method such as block encoding, convolutional encoding, or turbo encoding. Here, the encoding may be performed by polar code encoding or low density parity check code (LDPC code) encoding. The transmission processing unit 311 modulates encoded bits by a predetermined modulation system such as BPSK, QPSK, 16QAM, 64QAM, or 256QAM. In this case, signal points on a constellation do not necessarily have to be equidistant. The constellation may be a non uniform constellation (NUC). The transmission processing unit 311 multiplexes a modulation symbol of each channel and a downlink reference signal and arranges the same in a predetermined resource element. The transmission processing unit 311 performs various types of signal processing on the multiplexed signal. For example, the transmission processing unit 311 performs processing such as conversion into a frequency domain by fast Fourier transform, addition of a guard interval (cyclic prefix), generation of a baseband digital signal, conversion into an analog signal, orthogonal modulation, up-conversion, removal of an extra frequency component, and power amplification. The signal generated by the transmission processing unit 311 is transmitted from the antenna 313.

The reception processing unit 312 processes an uplink signal received via the antenna 313. For example, the reception processing unit 312 performs down-conversion, removal of an unnecessary frequency component, control of an amplification level, orthogonal demodulation, conversion into a digital signal, removal of guard interval (cyclic prefix), extraction of a frequency domain signal by fast Fourier transform or the like on the uplink signal. The reception processing unit 312 separates an uplink channel and an uplink reference signal such as a physical uplink shared channel (PUSCH) and a physical uplink control channel (PUCCH) from the signals subjected to such processing. The reception processing unit 312 demodulates a reception signal using a modulation system such as binary phase shift keying (BPSK) or quadrature phase shift keying (QPSK) with respect to the modulation symbol of the uplink channel. The modulation system used for demodulation may be 16 quadrature amplitude modulation (QAM), 64QAM, or 256QAM. In this case, signal points on a constellation do not necessarily have to be equidistant. The constellation may be a non-uniform constellation (NUC). The reception processing unit 312 performs decoding processing on the demodulated encoded bits of the uplink channel. The decoded uplink data and uplink control information are output to the control unit 33.

The antenna 313 is an antenna device (antenna unit) that mutually convert a current and a radio wave. The antenna 313 may include one antenna element (for example, one patch antenna) or may include a plurality of antenna elements (for example, a plurality of patch antennas). In a case where the antenna 313 includes a plurality of antenna elements, the radio communication unit 31 may be configured to be able to perform beamforming. For example, the radio communication unit 31 may be configured to generate a directional beam by controlling directivity of a radio signal using a plurality of antenna elements. Note that, the antenna 313 may be a dual-polarized antenna. In a case where the antenna 313 is the dual-polarized antenna, the radio communication unit 31 may use the vertically polarized wave (V polarized wave) and the horizontally polarized wave (H polarized wave) when transmitting the radio signal. The radio communication unit 31 may control the directivity of the radio signal transmitted using the vertically polarized wave and the horizontally polarized wave. The radio communication unit 31 may transmit and receive spatially multiplexed signals via a plurality of layers including a plurality of antenna elements.

The storage unit 32 is a storage device capable of reading and writing data, such as a DRAM, an SRAM, a flash memory, or a hard disk. The storage unit 32 functions as a storage means of the base station 30.

The control unit 33 is a controller that controls each unit of the base station 30. The control unit 33 is implemented by, for example, a processor such as a central processing unit (CPU) and a micro processing unit (MPU). For example, the control unit 33 is implemented by a processor executing various programs stored in a storage device in the base station 30 using a random access memory (PAM) or the like as a work area. Note that, the control unit 33 may be implemented by an integrated circuit such as an application specific integrated circuit (ASIC) and a field programmable gate array (FPGA). Any of the CPU, MPU, ASIC, and FPGA can be regarded as a controller. The control unit 33 may be implemented by a graphics processing unit (GPU) in addition to or instead of the CPU.

In some embodiments, the concept of the base station may include a set of a plurality of physical or logical devices. For example, in this embodiment, the base station may be distinguished into a plurality of devices such as a baseband unit (BBU) and a radio unit (RU). The base station may be interpreted as an assembly of the plurality of devices. The base station may be either or both of the BBU and RU. The BBU and RU may be connected by a predetermined interface (for example, enhanced common public radio interface (eCPRI)). Note that, the RU may be referred to as a remote radio unit (RRU) or a radio dot (RD). The RU may support a gNB distributed unit (gNB-DU) to be described later. Moreover, the BBU may support a gNB central unit (gNB-CU) to be described below. Alternatively, the RU may be a radio device connected to a gNB-DU to be described later. The RU connected to the gNB-CU, gNB-DU, and gNB-DU may be configured to conform to an open radio access network (O-RAN). Moreover, the RU may be a device integrally formed with the antenna. An antenna (for example, the antenna integrally formed with the RU) included in the base station may adopt an advanced antenna system and support MIMO (for example, full dimension (FD)-MIMO) or beamforming. The antenna included in the base station may be provided with, for example, 64 transmission antenna ports and 64 reception antenna ports.

The antenna mounted on the RU may be an antenna panel including one or more antenna elements, and the RU may be equipped with one or more antenna panels. For example, the RU may be equipped with two types of antenna panels of a horizontally polarized wave antenna panel and a vertically polarized wave antenna panel, or two types of antenna panels of a right-turn circular polarized wave antenna panel and a left-turn circular polarized wave antenna panel. The RU may form an independent beam for each antenna panel and control.

Note that, a plurality of base stations may be connected to each other. One or a plurality of base stations may be included in a radio access network (RAN). In this case, the base station may be simply referred to as a RAN, a RAN node, an access network (AN), or an AN node. Note that, the RAN in LTE is sometimes referred to as an enhanced universal terrestrial RAN (EUTRAN). The RAN in NR is sometimes referred to as NGRAN. The RAN in W-CDMA (UMTS) is sometimes referred to as UTRAN.

Note that, an LTE base station is sometimes referred to as evolved node B (eNodeB) or eNB. At that time, the EUTRAN includes one or a plurality of eNodeBs (eNBs). An NR base station is sometimes referred to as gNodeB or gNB. At that time, the NGRAN includes one or a plurality of gNBs. The EUTRAN may include a gNB (en-gNB) connected to a core network (EPC) in an LTE communication system (EPS). Similarly, the NGRAN may include an ng-eNB connected to a core network 5GC in a 5G communications system (5GS).

Note that, in a case where the base station is the eNB, gNB or the like, the base station is sometimes referred to as 3GPP access. In a case where the base station is a radio access point, the base station is sometimes referred to as non-3GPP access. Moreover, the base station may be an optical extension device referred to as a remote radio head (RRH) or a radio unit (RU). In a case where the base station is the gNB, the base station may be a combination of the gNB-CU and gNB-DU described above, or may be any one of the gNB-CU and gNB-DU.

Here, the gNB-CU hosts a plurality of upper layers (for example, radio resource control (RRC), service data adaptation protocol (SDAP), and packet data convergence protocol (PDCP)) in an access stratum for communication with the UE. In contrast, the gNB-DU hosts a plurality of lower layers (for example, radio link control (RLC), medium access control (MAC), and physical layer (PHY)) in an access stratum. That is, out of messages/information to be described later, RRC signaling (semi-static notification) may be generated by the gNB-CU, whereas MAC CE and DCI (dynamic notification) may be generated by the gNB-DU. Alternatively, in RRC configuration (semi-static notification), for example, some configurations such as IE: cellGroupConfig may be generated by the gNB-DU, and the remaining configurations may be generated by the gNB-CU. These configurations may be transmitted and received through an F1 interface to be described later.

Note that, the base station may be capable of performing communication with another base station. For example, in a case where a plurality of base stations is the eNBs or a combination of the eNB and en-gNB, the base stations may be connected by the X2 interface. In a case where a plurality of base stations is the gNBs or a combination of the gn-eNB and gNB, the devices may be connected by the Xn interface. In a case where a plurality of base stations is a combination of the gNB-CU and gNB-DU, the devices may be connected by the F1 interface described above. A message/information (for example, RRC signaling, MAC control element (MAC CE), or DCI) to be described later may be transmitted between a plurality of base stations, for example, via the X2 interface, Xn interface, or F1 interface.

A cell provided by the base station is sometimes referred to as a serving cell. The concept of the serving cell includes a primary cell (PCell) and a secondary cell (SCell). In a case where dual connectivity is set in the UE (for example, the terminal device 40), the PCell provided by a master node (NM) and zero or one or more SCells may be referred to as a master cell group. Examples of the dual connectivity include EUTRA-EUTRA dual connectivity, EUTRA-NR dual connectivity (ENDC), EUTRA-NR dual connectivity with 5GC, NR-EUTRA dual connectivity (NEDC), and NR-NR dual connectivity.

Note that, the serving cell may include a primary secondary cell (PSCell) or a primary SCG cell. In a case where the dual connectivity is set in the UE, the PSCell provided by the secondary node (SN) and zero or one or more SCells may be referred to as a secondary cell group (SCG). Unless specially configured (for example, PUCCH on SCell), the physical uplink control channel (PUCCH) is transmitted by the PCell and PSCell, but is not transmitted by the SCell. A radio link failure is also detected in the PCell and PSCell, but is not detected in the SCell (not necessarily be detected). In this manner, since the PCell and PSCell have a special role in the serving cell, they are also referred to as special cell (SpCell).

One downlink component carrier and one uplink component carrier may be associated with one cell. A system bandwidth corresponding to one cell may be divided into a plurality of bandwidth parts (BWPs). In this case, one or a plurality of BWPs may be set in the UE, and one BWP may be used for the UE as an active BWP. Radio resources (for example, a frequency band, numerology (subcarrier spacing), and a slot format (slot configuration) that can be used by the terminal device 40 may be different for each cell, each component carrier, or each BWP.

### <2-4. Configuration of Terminal Device>

Next, a configuration of the terminal device 40 is described.

The terminal device 40 is the radio communication device that performs the radio communication with another communication device such as the base station 30. The terminal device 40 can perform communication using a plurality of communication paths simultaneously (hereinafter, also referred to as simultaneous communication). At that time, a plurality of communication paths that can be used by the terminal device 40 may be associated with different subscriber identity modules (SIMs).

The terminal device 40 is, for example, a mobile terminal such as a mobile phone, a smart device (smartphone or tablet), a personal digital assistant (PDA), or a notebook PC. The terminal device 40 may be a device such as a business camera having a communication function, or may be a motorcycle, a moving relay vehicle or the like equipped with a communication device such as a field pickup unit (FPU). The terminal device 40 may be a machine to machine (M2M) device or an Internet of things (IoT) device. The terminal device 40 may be a wearable device such as a smart watch.

Note that, the terminal device 40 may be an xR device such as an augmented reality (AR) device, a virtual reality (VR) device, or a mixed reality (MR) device. At that time, the xR device may be a glasses-type device such as AR glasses and MR glasses, or may be a head-mounted device such as a VR head-mounted display. In a case where the terminal device 40 is the xR device, the terminal device 40 may be a standalone device including only a user wearing portion (for example, the eyeglass portion). The terminal device 40 may be a terminal interlocking device including the user wearing portion (for example, the eyeglass portion) and a terminal portion (for example, a smart device) interlocked with the portion.

Note that, the terminal device 40 may be capable of performing the NOMA communication with the base station 30. The terminal device 40 may be capable of using the automatic retransmission technology such as HARQ when communicating with the base station 30. The terminal device 40 may be capable of performing sidelink communication with another terminal device 40. The terminal device 40 may be capable of using the automatic retransmission technology such as HARQ also when performing the sidelink communication. Note that, the terminal device 40 may be capable of performing the NOMA communication also in communication (sidelink) with another terminal device 40. The terminal device 40 may be capable of performing the LPWA communication with another communication device (for example, the base station 30 and another terminal device 40). It goes without saying that the radio communication used by the terminal device 40 may be radio communication using a millimeter wave. Note that, the radio communication (including the sidelink communication) used by the terminal device 40 may be radio communication using radio waves or radio communication (optical radio) using infrared rays or visible light.

The terminal device 40 may be a mobile body device. The mobile body device is a movable radio communication device. At that time, the terminal device 40 may be a radio communication device installed in the mobile body or may be the mobile body itself. For example, the terminal device 40 may be a vehicle that moves on a road such as an automobile, a bus, a truck, or a motorcycle, a vehicle that moves on a rail installed on a track such as a train, or a radio communication device mounted on the vehicle. Note that, the mobile body may be a mobile terminal, or may be a mobile body that moves on the land (on the ground in a narrow sense), underground, on water, or underwater. The mobile body may be a mobile body that moves in the atmosphere such as a drone or a helicopter, or may be a mobile body that moves outside the atmosphere such as an artificial satellite.

The terminal device 40 may be connected to a plurality of base stations or a plurality of cells simultaneously to perform communication. For example, in a case where one base station supports a communication area via a plurality of cells (for example, pCell, sCell), it is possible to bundle the plurality of cells and communicate between the base station 30 and the terminal device 40 by a carrier aggregation (CA) technology, a dual connectivity (DC) technology, and a multi-connectivity (MC) technology. Alternatively, it is also possible that the terminal device 40 and the plurality of base stations 30 communicate with each other by a coordinated multi-point transmission and reception (CoMP) technology via the cells of the different base stations 30.

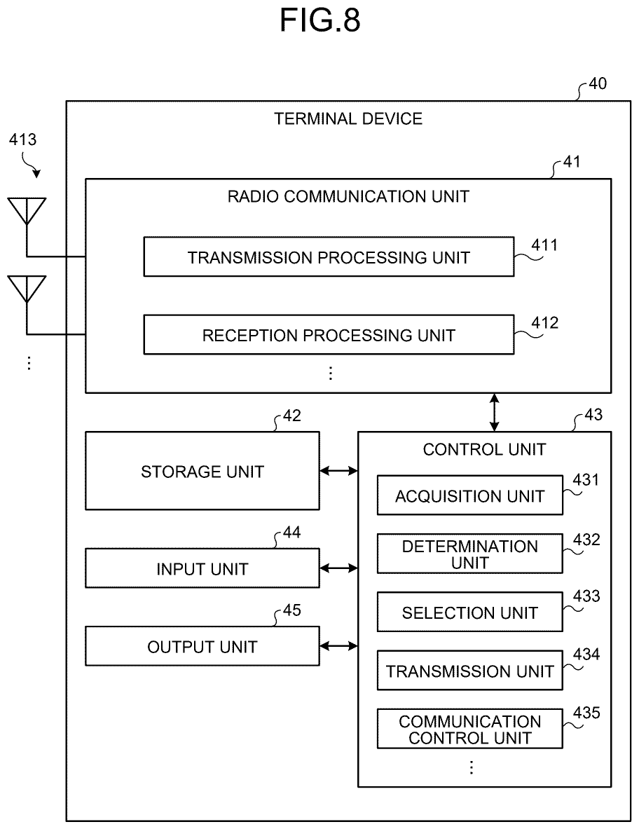

FIG. 8 is a diagram illustrating a configuration example of the terminal device 40 according to the embodiment of the present disclosure. The terminal device 40 is provided with a radio communication unit 41, a storage unit 42, a control unit 43, an input unit 44, and an output unit 45. Note that, the configuration illustrated in FIG. 8 is a functional configuration, and a hardware configuration may be different from this. The functions of the terminal device 40 may be implemented in a distributed manner in a plurality of physically separated configurations.

The radio communication unit 41 is a signal processing unit for performing the radio communication with other radio communication devices (for example, the base station 30 and another terminal device 40). The radio communication unit 41 operates under control of the control unit 43. The radio communication unit 41 is provided with a transmission processing unit 411, a reception processing unit 412, and an antenna 413. Configurations of the radio communication unit 41, the transmission processing unit 411, the reception processing unit 412, and the antenna 413 may be similar to those of the radio communication unit 31, the transmission processing unit 311, the reception processing unit 312, and the antenna 313 of the base station 30. The radio communication unit 41 may be configured to be able to perform beamforming similarly to the radio communication unit 31. Moreover, similarly to the radio communication unit 31, the radio communication unit 41 may be capable of transmitting and receiving the spatially multiplexed signals.

The storage unit 42 is a storage device capable of reading and writing data, such as a DRAM, an SRAM, a flash memory, or a hard disk. The storage unit 42 functions as a storage means of the terminal device 40. The storage unit 42 stores a prediction model (learning model) for predicting the quality of the communication path.

The control unit 43 is a controller that controls each unit of the terminal device 40. The control unit 43 is implemented by, for example, a processor such as a CPU or an MPU. For example, the control unit 43 is implemented by a processor executing various programs stored in a storage device in the terminal device 40 using a RAM or the like as a work area. Note that, the control unit 43 may be implemented by an integrated circuit such as an ASIC or an FPGA. Any of the CPU, MPU, ASIC, and FPGA can be regarded as a controller. The control unit 43 may be implemented by a GPU in addition to or instead of the CPU.

As illustrated in FIG. 8, the control unit 43 is provided with an acquisition unit 431, a determination unit 432, a selection unit 433, a transmission unit 434, and a communication control unit 435. Each block (acquisition unit 431 to communication control unit 435) forming the control unit 43 is a functional block indicating a function of the control unit 43. These functional blocks may be software blocks or hardware blocks. For example, each of the functional blocks described above may be one software module implemented by software (including microprogram), or may be one circuit block on a semiconductor chip (die). It goes without saying that each functional block may be one processor or one integrated circuit. Note that, the control unit 43 may be configured by a functional unit different from the above-described functional block. A configuration method of the functional block is optional. An operation of the control unit 43 may be the same as an operation of each block of the control unit 13 of the server 10.

The input unit 44 is an input device that receives various inputs from the outside. For example, the input unit 44 is an operation device for the user to perform various operations, such as a keyboard, a mouse, and operation keys. Note that, in a case where a touch panel is adopted as the terminal device 40, the touch panel is also included in the input unit 44. In this case, the user performs various operations by touching a screen with a finger or a stylus.

The output unit 45 is a device that performs various outputs by sound, light, vibration, an image and the like to the outside. The output unit 45 performs various outputs to the user under control of the control unit 43. Note that, the output unit 45 is provided with a display device that displays various types of information. The display device is, for example, a liquid crystal display or an organic electro luminescence (EL) display. Note that, the output unit 45 may be a touch panel type display device. In this case, the input unit 44 and the output unit 45 may be regarded as an integrated configuration. The output unit 45 may be an output unit of the xR device such as the AR glasses.

### 3. Operation of Communication System

The configuration of the communication system 1 is described above, and the operation of the communication system 1 having such a configuration is described next.

### 3-1. Outline of Operation of Communication System

The terminal device 40 or the server 10 collects information regarding communication in real time from each of a plurality of entities forming the communication system 1. The terminal device 40 or the server 10 evaluates or predicts the radio communication quality of the communication path (bearer) on the basis of the information regarding the communication. The terminal device 40 or the server 10 performs communication control regarding the communication service on the basis of an evaluation result or a prediction result. As a result, it is possible to provide a high-quality and stable communication service (for example, streaming distribution).

### <3-1-1. Entity>

In the present embodiment, following three entities (1) to (3) are assumed as the entities as an information collection target.

### (1) First Entity (Network)

The first entity is a mobile network (hereinafter, also simply referred to as a network). The network is, for example, a 5G mobile network (5G cellular network). The network may be a core network (for example, the management device 20). In a case where the first entity is the core network, the terminal device 40 or the server 10 collects information via, for example, a network exposure function (NEF) and/or an application function (AF).

### (2) Second Entity (Service)

The second entity is a service (for example, a streaming distribution service). The service is, for example, a transmission/reception application on a mobile device and/or a transmission/reception server on a cloud. Here, the mobile device may be the terminal device 40. The transmission/reception server on the cloud may be the server 10.

### (3) Third Entity (UE)

The third entity is user equipment (UE). The third entity may be a radio data monitoring/collecting/notifying process on the mobile device. Here, the UE and the mobile device may be the terminal device 40.

### <3-1-2. Candidate of Collected Data>

In the present embodiment, the terminal device 40 or the server 10 collects all or part of the data indicated in the following (1) to (3) as the information regarding the communication.

(1) Candidate of Data Collected from Network

Examples of a candidate of data collected from the mobile network by the terminal device 40 or the server 10 include information on a congestion degree of the mobile network (hereinafter, referred to as congestion degree information). If there is a plurality of communication paths that can be used by the terminal device 40, the collected data may be the congestion degree information for each communication path. Here, examples of a candidate of the congestion degree information include information on a resource occupancy rate of the base station 30 (for example, Congestion info in Analytics data provided to AF via NEF), the number of pieces of UE connected to the base station 30, and a load rate of the base station/core network (CPU/memory/network). The collected data may be quality of service (QoS) setting of the communication path of the UE or radio quality information of the UE.

(2) Candidate of Data Collected from Service

Examples of a candidate of data collected from the service by the terminal device 40 or the server 10 include information on service quality (hereinafter referred to as service quality information). If there is a plurality of communication paths that can be used by the terminal device 40, the collected data may be service quality information for each communication path. Here, examples of a candidate of the service quality information include information on a communication quality characteristic (for example, throughput, traffic pattern and the like) or an actually measured value of end-to-end communication quality (for example, the number of successfully transmitted packets, a packet loss rate and the like).

(3) Candidate of Data Collected from UE

Examples of a candidate of data collected from the UE by the terminal device 40 or the server 10 include information on service quality between the terminal device 40 and the base station 30 (hereinafter referred to as radio quality information). If there is a plurality of communication paths that can be used by the terminal device 40, the collected data may be the radio quality information for each communication path. In addition, examples of the candidate of the collected data include a connected device (for example, a camera or the like), mobility (information regarding movement), activity, uplink transmission power and transmission power margin, a specific absorption rate (SAR), a reduction in maximum transmission power due to backoff, current temperature of a terminal, a predicted heating value, a type/number of available bearers, and a remaining battery level.

### <3-1-3. Outline of Communication Control>

The terminal device 40 or the server 10 performs communication control on the basis of a prediction result (or an evaluation result) of the quality of the communication path (bearer). Here, the communication control may be control of a parameter regarding the communication quality. For example, the terminal device 40 or the server 10 may adjust the streaming quality of the application (bit rate change, change in redundant packet rate, control of transmission timing of service-specific secondary data) on the basis of the prediction result (or the evaluation result). The terminal device 40 or the server 10 may control a transmission policy of the application (when and which data to transmit) as the communication control.

Note that, in a case where the terminal device 40 can perform communication (hereinafter, referred to as simultaneous communication) using a plurality of communication paths simultaneously, the terminal device 40 or the server 10 may control the mode when the terminal device 40 performs the simultaneous communication, or may control the communication path used by the terminal device 40. Here, the simultaneous communication may be, for example, communication by dual SIM dual active (DSDA). A plurality of communication paths may be cellular+cellular (for example, DSDA) or cellular+WiFi. Here, a plurality of modes selectable when the terminal device 40 performs the simultaneous communication may include the redundant communication mode (first mode) and the high-speed communication mode (second mode). The redundant communication mode is a mode for improving communication reliability by transmitting the same packet to a plurality of communication paths. The high-speed communication mode is a mode for improving throughput by transmitting different packets to a plurality of communication paths.

The terminal device 40 or the server 10 may entirely optimize the QoS setting of the communication path (for example, slice) according to the service quality requested by the UE or priority. For example, the terminal device 40 or the server 10 sets the communication quality of each of a plurality of pieces of UE (slices) so that the communication quality of an entire network is optimized using API for QoS control opened by the mobile network via the NEF. As a result, for example, QoS of the UE with a high priority can be ensured.

### 3-2. Communication Mode

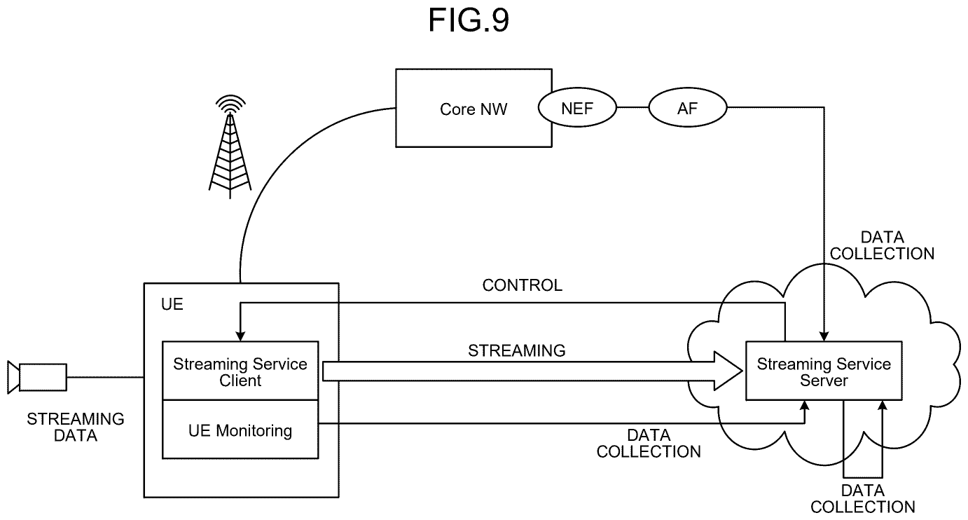

Although the outline of the operation of the communication system 1 is described above, a communication mode assumed by the present embodiment is described before describing the operation of the communication system 1 in detail. In the present embodiment, three types of communication modes indicated in following (1) to (3) are assumed. Hereinafter, the three types of communication modes are described with reference to FIGS. 9 to 13.

Note that, in the drawing, the core network (core NW) is the first entity (network), a streaming service server and/or a streaming service client is the second entity (service), and the UE or UE monitoring is the third entity (UE). The core network corresponds to the management device 20, the streaming service server corresponds to the server 10, and the UE corresponds to the terminal device 40. Note that, in the example of FIGS. 9 to 13, the streaming data is transmitted from the UE to the server, but the streaming data may be transmitted from the server to the UE.

### (1) First Communication Mode (Basic Mode)

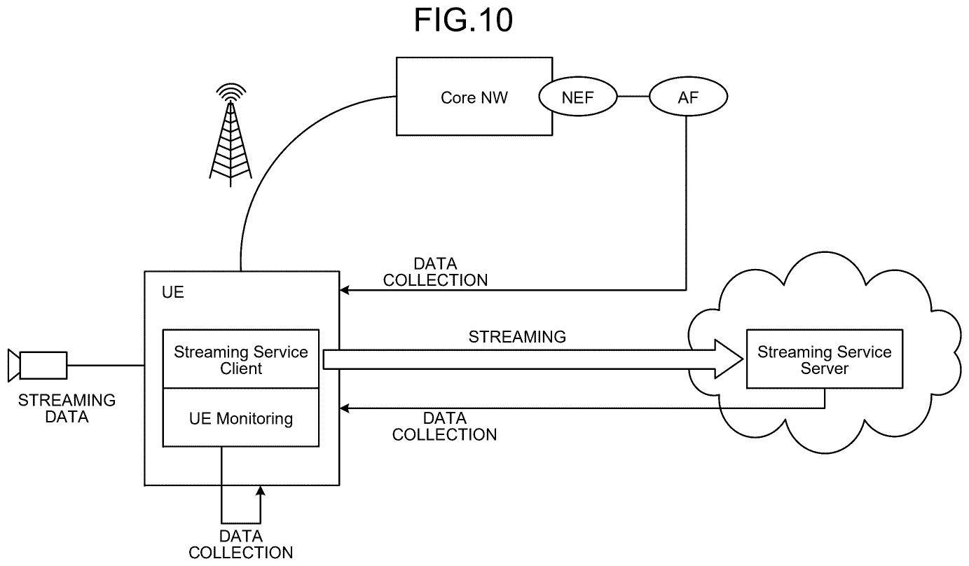

A first communication mode is a basic communication mode. FIGS. 9 and 10 are diagrams for illustrating the first communication mode. In an example of FIG. 9, the streaming service server collects data from each entity to control communication of a service (streaming service client). In an example of FIG. 10, the UE collects data from each entity and controls the service (streaming service client). In the examples of FIGS. 9 and 10, a control target is the streaming service client, but the control target may be the streaming service server.

### (2) Second Communication Mode (Utilization of Plurality of Communication Paths)

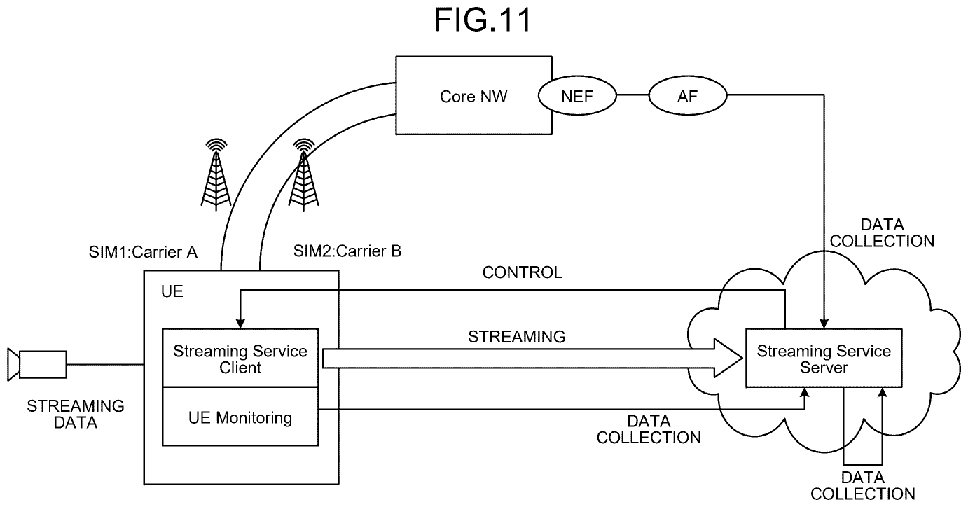

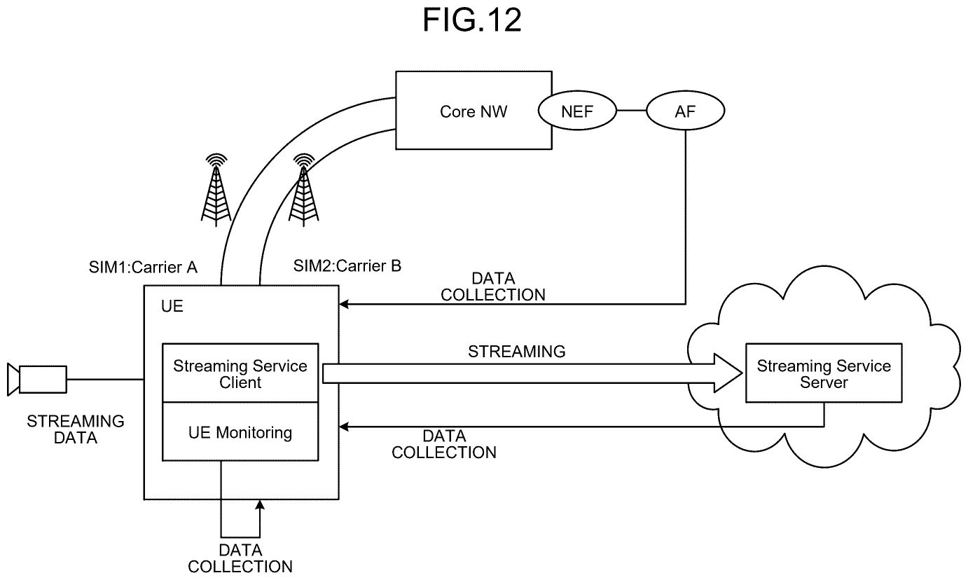

A second communication mode is a communication mode utilizing a plurality of communication paths. FIGS. 11 and 12 are diagrams for illustrating the second communication mode. In the second communication mode, the UE can perform communication using a plurality of communication paths associated with different SIMs simultaneously. A plurality of communication paths may be different slices. In an example of FIG. 11, the streaming service server collects data from each entity to control communication of a service (streaming service client). In an example of FIG. 12, the UE collects data from each entity and controls the service (streaming service client). In the examples of FIGS. 11 and 12, a control target is the streaming service client, but the control target may be the streaming service server.

### (3) Third Communication Mode (Entire Optimization of Mobile Network)

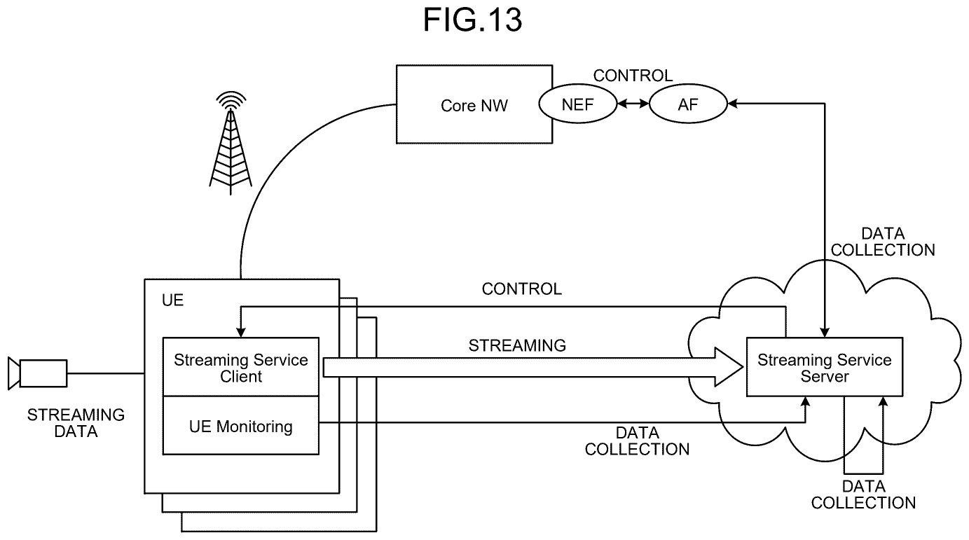

A third communication mode is a communication mode in which the server controls communication regarding a plurality of pieces of UE. FIG. 13 is a diagram for illustrating the third communication mode. In the third communication mode, a plurality of pieces of UE receives the streaming service via the mobile network. The streaming service server controls the communication of each of a plurality of pieces of UE in such a manner that the communication quality is optimized in an entire mobile network. In the example of FIG. 13, a control target is the streaming service client, but the control target may be the streaming service server. For example, the streaming service server may adjust QoS preferential setting of a plurality of pieces of UE so that the communication quality of the entire network is optimized using API for QoS control opened by the core network via the NEF. In the example of FIG. 13, the streaming service server controls the UE and the core network, but the UE may control the streaming service server and the core network.

### 3-3. First Embodiment

On the basis of the above, an operation of a communication system 1 of a first embodiment is described in detail.

In the first embodiment, a terminal device 40 is configured to be able to perform communication using a plurality of communication paths simultaneously. At that time, a plurality of communication paths may be communication paths of a plurality of cellular networks provided by a plurality of operators (for example, a mobile phone business operator). For example, the terminal device 40 may support dual SIM dual active (DSDA), and a plurality of communication paths may be associated with different SIMs. The terminal device 40 performs communication control regarding a service on the basis of information (information regarding communication) collected from a plurality of entities forming the communication system 1. In the first embodiment, the terminal device 40 performs information collection and communication control, but a server 10 may perform the information collection and/or communication control.

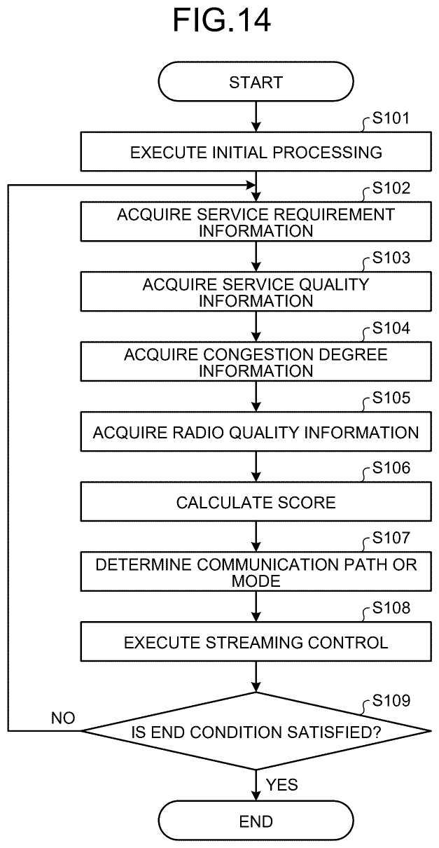

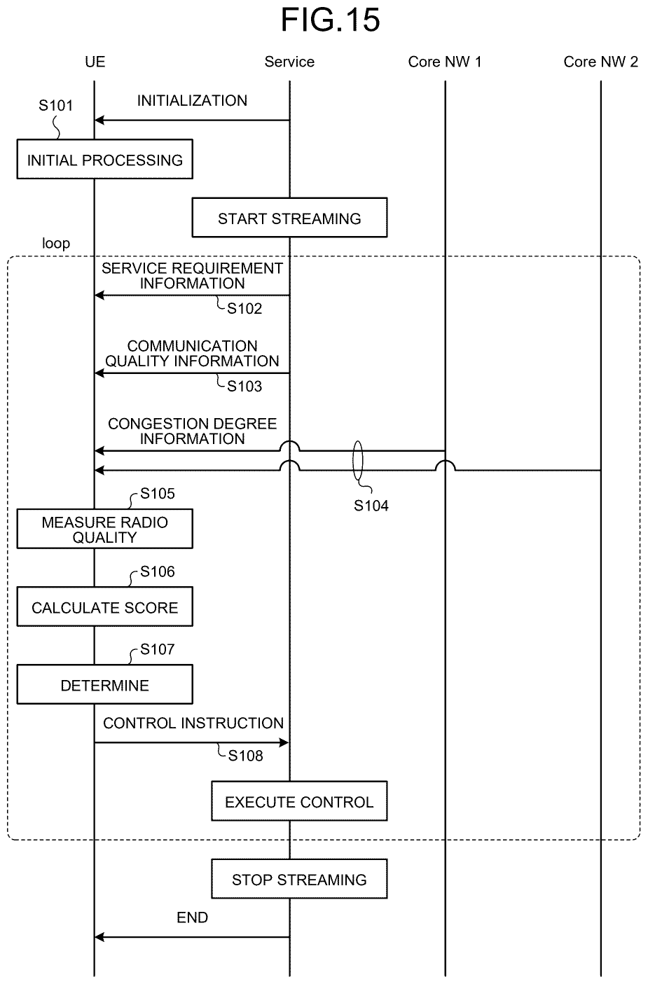

FIG. 14 is a flowchart illustrating communication control processing of the first embodiment. FIG. 15 is a sequence diagram illustrating the communication control processing of the first embodiment. Note that, the following processing is assumed to be executed by a control unit 43 of the terminal device 40, but a part of or entire following processing may be executed by a control unit 13 of the server 10. A part of or entire following processing may be executed by a control unit 23 of a management device 20 or may be executed by a control unit 33 of a base station 30. Hereinafter, the communication control processing of the first embodiment is described with reference to the flowchart of FIG. 14 and the sequence diagram of FIG. 15.

When receiving an initialization instruction from a service (second entity), a communication control unit 435 of the terminal device 40 executes initial processing (for example, initialization of a streaming buffer, initialization of various variables and the like) regarding a streaming service (step S101). As described above, the second entity may be a transmission/reception application on the terminal device 40, the server 10, or both. When the initial processing of the terminal device 40 is completed, the service (second entity) starts streaming.

Subsequently, an acquisition unit 431 of the terminal device 40 acquires service requirement information from the service (second entity) (step S102). The service requirement information is information indicating a communication quality requirement of the service (information indicating a quality level required by the service). The service requirement information may include, for example, information indicating a line use mode and information indicating a throughput range required by the service. The information indicating the line use mode and the information indicating the throughput range may be, for example, information indicated by following (1) and (2).

### (1) Line Use Mode

Redundancy priority
High-speed priority (band priority)
Power consumption reduction (wasteful traffic reduction)
Combination of above

### (2) Throughput Range

Min: XX mbps
Default: YY mbps
Max: ZZ mbps

Here, the redundancy priority is a mode prioritizing redundant communication, the high-speed priority (band priority) is a mode prioritizing high-speed communication, and the power consumption reduction is a mode prioritizing reduction in power consumption.

Subsequently, the acquisition unit 431 of the terminal device 40 acquires service requirement information for each communication path from the service (second entity) (step S103). The service quality information is information on end-to-end service quality (between the terminal device 40 and the server 10). For example, the service quality information is a score (first score) calculated on the basis of a value (for example, at least one of a loss rate, delay, and a throughput value) actually measured by the second entity. At that time, the service quality information may be a value obtained by scoring the loss rate at the time of occurrence of communication of 1 Mbps or higher by the terminal device 40 or the service with a following threshold.

$$Score \text{:} loss rate$$

$$1. : <= 0.01 \%$$

$$0.9 : <= 0.03 \%$$

$$0.8 : <= 0.05 \%$$

$$0.7 : <= 0.5 \%$$

$$… ∶ <= …$$

$$0.1 : >= 5 \%$$

In a case of the above-described example, when the loss rate is 0.02%, the score is 0.9.

Subsequently, the acquisition unit 431 of the terminal device 40 acquires congestion degree information for each communication path from a network (first entity) (step S103). The congestion degree information is information indicating a congestion degree of the network. For example, the congestion degree information is an occupancy rate of resources of the base station 30. At that time, an occupancy rate (R) may be a value calculated by following formula (1) on the basis of the total number (N1) of resource blocks that can be allocated per unit time by the base station 30 and the number (N2) of resource blocks actually allocated to all pieces of UE connected to the base station 30.

$$R = N 2 / N 1 \qquad ( 1 )$$

Note that, the congestion degree information may be a value scored by the terminal device 40 or the first entity on the basis of the above-described occupancy rate (R). For example, a score (second score) indicating the congestion degree information may be a score calculated by following formula (2).

$$Score = ( 1. - R ) \times k \qquad ( 2 )$$

Here, k is a coefficient. In a case of the above example, when R=0.2 and k=1.0, the score is 0.8 (=1.0−0.2).

Note that, the congestion degree information may take uncertainty of future communication resource tightness into consideration. For example, the congestion degree information may be a score calculated on the basis of information on the number of pieces of UE connected to the base station 30. For example, the score (second score) indicating the congestion degree information may be a score calculated by multiplying the score calculated by above formula (2) by a predetermined value in a case where it is discriminated that the number of connections of UE is a predetermined threshold or larger. For example, it is assumed that the score calculated by above formula (2) is 0.8 and the number of connections of UE is the predetermined threshold or larger (for example, 10 or larger). At that time, if the predetermined value is 0.8, the score indicating the congestion degree information is 0.64 (=0.8×0.8). Note that, the predetermined threshold may be a value adjusted for each frequency.

Subsequently, the acquisition unit 431 of the terminal device 40 acquires radio quality information for each communication path (step S103). The radio quality information may be measured by the terminal device 40 or may be acquired by the terminal device 40 from the network (first entity) via AF. Here, the radio quality information is information on radio quality between the terminal device 40 and the base station 30. For example, the radio quality information is a score (second score) calculated on the basis of a parameter regarding the radio quality (for example, at least one of reference signal received power (RSRP), reference signal received quality (RSRQ), and signal to interference and noise (SINR)). At that time, the radio quality information may be a value obtained by scoring the RSRQ using a following threshold by the terminal device 40 or the first entity.

$$Score \text{:} RSRQ$$

$$1. : >= - 3 dB$$

$$0.9 : >= - 5 dB$$

$$0.8 : >= - 8 dB$$

$$… ∶ >= …$$

$$0.1 : >= - 19.5 dB$$

In a case of the above example, when the RSRQ is −8 dB, the score is 0.8.

Next, a determination unit 432 of the terminal device 40 calculates a score (fourth score) indicating the quality of the communication path for each communication path on the basis of the information regarding the communication (service quality information, congestion degree information, and radio quality information) acquired at steps S103 to S105 (step S106). For example, the terminal device 40 calculates the fourth score by weighting and counting the scores (for example, first score to third score) acquired at steps S103 to S105. It goes without saying that a method for calculating the fourth score is not limited to the weighted addition. The terminal device 40 may directly set any one of the first score to the third score as the fourth score. The terminal device 40 may convert the fourth score into a predetermined number of levels. For example, the terminal device 40 may convert the fourth score into three levels. In the following description, it is assumed that the terminal device 40 converts the fourth score into three levels (good/average/poor). In the following description, the converted level may also be referred to as the fourth score.

Next, the determination unit 432 of the terminal device 40 determines a content of communication control regarding the service on the basis of the score calculated at step S106 (step S107). For example, the terminal device 40 determines (1) one of a plurality of communication paths, or (2) a mode when the terminal device 40 performs simultaneous communication on the basis of the score calculated at step S106. Here, each determined content may be as follows.

### (1) Determination of Communication Path

For example, the terminal device 40 determines a communication path having the highest fourth score out of a plurality of communication paths as a communication path to be used in the service (for example, the streaming service). Note that, in order to prevent frequent switching of the communication path, hysteresis may be provided in determination of the communication path based on the fourth score. For example, even if the currently used communication path is a first communication path and the score of a second communication path is higher than the score of the first communication path, in a case where the score of the second communication path is not higher than the score of the first communication path by a predetermined value or more, the terminal device 40 may directly determine the first communication path as the communication path to be used in the service.

In addition to determining the communication path (alternatively, separately from determining the communication path), the terminal device 40 may adjust a parameter regarding communication quality of the service. For example, the terminal device 40 may calculate an expected throughput on the basis of the fourth score and perform rate control of the streaming on the basis of the calculated throughput. More specifically, the terminal device 40 calculates the expected throughput by multiplying a theoretical throughput by the fourth score. The terminal device 40 performs bit rate control of the service on the basis of a comparison result between the calculated expected throughput and the throughput (for example, a throughput range included in the service requirement information) required by the service.

### (2) Determination of Mode

For example, the terminal device 40 determines a mode when the terminal device 40 performs simultaneous communication out of a plurality of modes on the basis of a combination of the fourth scores. For example, it is assumed that the terminal device 40 can perform communication using the first communication path associated with a SIM 1 and the second communication path associated with a SIM 2 simultaneously. At that time, the terminal device 40 determines a mode when the terminal device 40 performs simultaneous communication out of a plurality of modes (high-speed communication mode and redundant communication mode) on the basis of a combination of the levels of the communication quality (good/average/poor) of the first communication path (SIM 1) and the levels of the communication quality (good/average/poor) of the second communication path (SIM 2). At that time, a relationship between the combination of the levels and the mode determined in the combination may be different depending on the service requirement information (for example, the line use mode) acquired at step S102.

Table 1 is a table illustrating a relationship between the combination of the levels and the mode determined in the combination when the line use mode is high-speed priority+redundancy priority.

TABLE 1
High-speed + redundant

SIM2

| SIM1 | Good | Average | Poor |
|---|---|---|---|
| Good | High-speed | High-speed | High-speed |
| | communication | communication | communication |
| Average | High-speed | High-speed | Redundant |
| | communication | communication | communication |
| Poor | High-speed | Redundant | Redundant |
| | communication | communication | communication |

For example, in a case where the line use mode is high-speed priority+redundancy priority, in a case where the level of the communication quality of one of the first communication path and the second communication path is good, or in a case where the level of the communication quality of both the first communication path and the second communication path is average, the terminal device 40 sets the mode at the time of simultaneous communication as the high-speed communication mode. In other cases, the mode at the time of simultaneous communication is set as the redundant communication mode.

### (3) Determination of Mode or Communication Path

Note that, the terminal device 40 may determine not only the mode but also the communication path to be used on the basis of the combination of the fourth scores.

Table 2 is a table illustrating a relationship between the combination of the levels and the mode or the communication path determined in the combination when the line use mode is redundancy priority+power consumption reduction.

TABLE 2
Redundancy priority + power consumption priority

SIM2

| SIM1 | Good | Average | Poor |
|---|---|---|---|
| Good | SIM1 or SIM2 | SIM1 | SIM1 |
| Average | SIM2 | Redundant | Redundant |
| | | communication | communication |
| Poor | SIM2 | Redundant | Redundant |
| | | communication | communication |

For example, in a case where the line use mode is redundancy priority+power consumption reduction, in a case where the level of the communication quality of both or any one of the first communication path and the second communication path is good, the terminal device 40 sets the communication path of any one of the first communication path and the second communication path as the communication path to be used in the service. Specifically, in a case where the level of the communication quality of both the first communication path and the second communication path is good, the terminal device 40 determines the first communication path or the second communication path as the communication path to be used in the service. In a case where the level of the communication quality of the first communication path is good, the terminal device 40 determines the first communication path as the communication path to be used in the service. In a case where the level of the communication quality of the second communication path is good, the terminal device 40 determines the second communication path as the communication path to be used in the service. In other cases, the terminal device 40 determines to perform simultaneous communication using both the first communication path and the second communication path. At that time, the terminal device 40 determines the redundant communication mode as a mode for simultaneous communication.

Table 3 is a table illustrating a relationship between the combination of the levels and the mode or the communication path determined in the combination when the line use mode is band priority+power consumption reduction.

TABLE 3
Band priority + power consumption priority

SIM2

| SIM1 | Good | Average | Poor |
|---|---|---|---|
| Good | SIM1 or SIM2 | SIM1 | SIM1 |
| Average | SIM2 | High-speed | High-speed |
| | | communication | communication |
| Poor | SIM2 | High-speed | High-speed |
| | | communication | communication |

For example, in a case where the line use mode is band priority+power consumption reduction, in a case where the level of the communication quality of both or any one of the first communication path and the second communication path is good, the terminal device 40 sets the communication path of any one of the first communication path and the second communication path as the communication path to be used in the service. Specifically, in a case where the level of the communication quality of both the first communication path and the second communication path is good, the terminal device 40 determines the first communication path or the second communication path as the communication path to be used in the service. In a case where the level of the communication quality of the first communication path is good, the terminal device 40 determines the first communication path as the communication path to be used in the service. In a case where the level of the communication quality of the second communication path is good, the terminal device 40 determines the second communication path as the communication path to be used in the service. In other cases, the terminal device 40 determines to perform simultaneous communication using both the first communication path and the second communication path. At that time, the terminal device 40 determines the high-speed communication mode as a mode at the time of simultaneous communication.

### (4) Determination Based on Service Requirement Information

The terminal device 40 may determine whether to perform the simultaneous communication or select the communication path on the basis of the service requirement information. For example, the terminal device 40 calculates the expected throughput for each of a plurality of communication paths by multiplying the theoretical throughput by the fourth score. The terminal device 40 determines whether to perform the simultaneous communication or select the communication path on the basis of a comparison result between the calculated expected throughput and the throughput (a throughput range included in the service requirement information) required by the service. For example, in a case where there is the communication path that satisfies the throughput required by the service, the terminal device 40 determines to use the communication path. In a case where the throughput required by the service can be satisfied in a plurality of communication paths, the terminal device 40 determines to perform the simultaneous communication. At that time, in a case where the throughput is equal to or greater than a predetermined threshold, the redundant communication mode is determined as the mode at the time of simultaneous communication, and in other cases, the high-speed communication mode is determined as the mode at the time of simultaneous communication. Note that, in a case where the throughput required by the service cannot be satisfied even if a plurality of communication paths is used, the terminal device 40 may determine to reduce a communication rate at the time of simultaneous communication.

Next, the communication control unit 435 of the terminal device 40 executes communication control of the service (second entity) according to a determined content at step S107 (step S108).

For example, when the communication path is determined at step S107 ((1) described above), the terminal device 40 notifies the service (second entity) to perform the communication using the determined communication path. The service (second entity) performs the communication according to the notification. This makes it possible to always implement streaming on a high-quality communication path.

When the rate of the streaming is determined at step S107 ((1) described above), the terminal device 40 notifies the service (second entity) to perform the communication using the determined rate. The service (second entity) performs the communication according to the notification. As a result, optimal bit rate control according to line quality can be implemented.

When the mode is determined at step S107 ((2) described above), the terminal device 40 notifies the service (second entity) to perform the communication using the determined mode. As a result, the terminal device 40 can implement high-quality and reliable streaming using a plurality of lines.

When the mode or communication path is determined at step S107 ((3) and (4) described above), the terminal device 40 notifies the service (second entity) to perform the communication using the determined mode or communication path. The service (second entity) performs the communication according to the notification. As a result, it is possible to prevent occurrence of wasteful traffic by not using an unusable communication path while implementing high-quality and reliable streaming using a plurality of lines.

When the mode or communication path is determined on the basis of the service requirement information at step S107 ((4) described above), the terminal device 40 notifies the service (second entity) to perform the communication using the determined mode or communication path. The service (second entity) performs the communication according to the notification. As a result, it is possible to implement optimum use of a plurality of communication paths according to service requirements.

Next, the terminal device 40 discriminates whether an end condition of the communication control processing is satisfied (step S109). For example, the terminal device 40 discriminates whether transmission of streaming data is completed. In a case where the end condition is not satisfied (step S109: No), the terminal device 40 returns the processing to step S102. In a case where the end condition is satisfied (step S109: Yes), the terminal device 40 ends the communication control processing.

According to the present embodiment, since the communication system 1 collects information in real time from a plurality of entities, this can evaluate the quality of each of a plurality of communication paths with high accuracy. Since the communication system 1 controls the parameter regarding the communication quality on the basis of an evaluation result, stable and high-quality streaming can be implemented.

### 3-4. Second Embodiment

Next, an operation of a communication system 1 of a second embodiment is described in detail.

In the second embodiment also, a terminal device 40 is configured to be able to perform communication using a plurality of communication paths simultaneously. In the first embodiment described above, the score (fourth score) indicating the communication path quality of each of a plurality of communication paths is calculated by performing weighted addition of the scores (for example, first score to third score) acquired at steps S103 to S105. In the second embodiment, the quality of each of a plurality of communication paths is predicted using a prediction model (learning model) generated by machine learning. Hereinafter, before describing the operation of the communication system 1 of the second embodiment, the prediction model (learning model) used in the second embodiment is described.

### <3-4-1. Prediction Model (Learning Model)>

As described above, a storage unit 42 of the terminal device 40 and a storage unit 12 of a server 10 store the prediction model (learning model) for predicting the quality of the communication path. The prediction model is the learning model for predicting future communication quality of the communication path that can be used by the terminal device 40.

The learning model is, for example, a machine learning model such as a neural network model. The neural network model includes layers referred to as an input layer including a plurality of nodes, an intermediate layer (or a hidden layer), and an output layer, and nodes are connected via edges. Each layer has a function referred to as an activation function, and each edge is weighted. The learning model includes one or a plurality of intermediate layers (or hidden layers). In a case where the learning model is the neural network model, learning of the learning model means, for example, setting the number of intermediate layers (or hidden layers), the number of nodes in each layer, the weight of each edge or the like.

Here, the neural network model may be a model by deep learning. In this case, the neural network model may be a model in a mode referred to as a deep neural network (DNN). The neural network model may be a model in a mode referred to as a convolution neural network (CNN), a recurrent neural network (RNN), or a long short-term memory (LSTM). It goes without saying that the neural network model is not limited to these modes of models.

The learning model is not limited to the neural network model. For example, the learning model may be a model by reinforcement learning. In the reinforcement learning, an action (setting) that maximizes a value through trial and error is learned. In addition, the learning model may be a logistic regression model.

Note that, the learning model may include a plurality of models. For example, the learning model may include a plurality of neural network models. More specifically, the learning model may include, for example, a plurality of neural network models selected from CNN, RNN, and LSTM. In a case where the learning model includes a plurality of neural network models, the plurality of neural network models may be in a dependency relationship or a parallel relationship.

As described above, the storage unit 42 of the terminal device 40 and the storage unit 12 of the server 10 store the learning model (hereinafter, referred to as a quality prediction model) for predicting the quality of the communication path. The quality prediction model is used in communication control processing to be described later. Hereinafter, the quality prediction model is described in detail.

The quality prediction model is, for example, the learning model (learned model) that learns with data (collected data) collected from each entity forming the communication system 1 as input data, and a degree of deterioration in communication quality of a corresponding communication path as a correct answer label (teacher data). Here, the collected data may be information regarding communication (for example, at least one of the service quality information, the congestion degree information, and the radio quality information). The degree of deterioration in communication quality may be an actually measured value (for example, an error rate and an actually measured throughput value) in a service, or may be an evaluation value (for example, the fourth score calculated at step S106 of the first embodiment) generated on the basis of a predetermined criterion. When the terminal device 40 or the server 10 inputs a parameter (for example, collected data) to the quality prediction model, the quality prediction model outputs, for example, information (for example, a score) indicating future communication quality of a corresponding communication path (bearer). The information indicating the future communication quality of the corresponding communication path (bearer) is sometimes referred to as communication quality information.

In this case, the quality prediction model may be the learning model that includes an input layer that inputs the parameter, an output layer that outputs information on communication quality, a first element that belongs to a layer being any layer from the input layer to the output layer and other than the output layer, and a second element a value of which is calculated on the basis of the first element and a weight of the first element, and causes a computer to function to output the information on communication quality from the output layer according to the parameter input to the input layer by performing an operation based on the first element and the weight (that is, a connection coefficient) of the first element with each element belonging to each layer other than the output layer as the first element with respect to the information input to the input layer.

Here, it is assumed that the learning model is implemented by a neural network including one or a plurality of intermediate layers such as the DNN. In this case, the first element included in the learning model corresponds to any node included in the input layer or the intermediate layer. The second element corresponds to a node at a next stage, the node to which a value is transmitted from the node corresponding to the first element. The weight of the first element corresponds to the connection coefficient that is the weight considered for the value transmitted from the node corresponding to the first element to the node corresponding to the second element.

It is assumed that the learning model is implemented by a regression model indicated by “y=a1*x1+a2*x2+ . . . +ai*xi”. In this case, the first element included in the learning model corresponds to input data (xi) such as x1 and x2. The weight of the first element corresponds to a coefficient ai corresponding to xi. Here, the regression model can be regarded as a simple perceptron including an input layer and an output layer. In a case where each model is regarded as the simple perceptron, the first element can be regarded to correspond to any node included in the input layer, and the second element can be regarded as the node included in the output layer.

The terminal device 40 or the server 10 calculates information to be output using a model having any structure such as the neural network or regression model. Specifically, in the quality prediction model, a coefficient is set so as to output the communication quality information in a case where data (for example, information regarding communication) collected from each entity forming the communication system 1 is input. For example, the terminal device 40 or the server 10 sets the coefficient on the basis of similarity between the data collected from each entity and a value obtained by inputting the degree of deterioration in communication quality to the learning model. The terminal device 40 or the server 10 generates the communication quality information from the collected data using such learning model.

Note that, in the above example, the model that outputs the communication quality information in a case where the parameter is input is illustrated as an example of the learning model. However, the learning model according to the embodiment may be a model generated on the basis of a result obtained by repeating input and output of data to and from the learning model.

In a case where the terminal device 40 or the server 10 performs learning using generative adversarial networks (GAN) or generation of output information, the learning model may be a model forming a part of the GAN.

Note that, the learning device that learns the learning model (for example, learning model) may be the server 10, the terminal device 40, or another information processing device. For example, it is assumed that the server 10 learns the learning model. In this case, the server 10 learns the learning model and stores the learned learning model in the storage unit 12. More specifically, the server 10 sets the connection coefficient of the learning model in such a manner that the learning model outputs the communication quality information when the collected data is input to the learning model.

For example, the terminal device 40 or the server 10 inputs the parameter to the node of the input layer included in the learning model, and causes data to propagate to the output layer of the learning model following each intermediate layer, thereby outputting the communication quality information or connection intention information. The terminal device 40 or the server 10 corrects the connection coefficient of the learning model on the basis of a difference between the communication quality information actually output by the learning model and the degree of deterioration in communication quality as the correct answer label (teacher data). At that time, the server 10 or the terminal device 40 may correct the connection coefficient using a method such as back propagation. At that time, the terminal device 40 or the server 10 may correct the connection coefficient on the basis of cosine similarity between a vector indicating the degree of deterioration in communication quality and a vector indicating a value actually output by the learning model.

Note that, any learning algorithm may be used for learning. For example, the terminal device 40 or the server 10 may learn the learning model using a learning algorithm such as the neural network, a support vector machine, clustering, reinforcement learning, random forest, or a decision tree.

The learning algorithm used in the present embodiment may be one in which the terminal device 40 and the server 10 independently learn, or one in which the terminal device 40 or the server 10 cooperatively learns. Here, an example of the learning algorithm that the server 10 and the terminal device 40 learn in cooperation with each other includes federated learning.

### <3-4-2. Communication Control Processing of Second Embodiment>

On the basis of the above, the operation of the communication system 1 of the second embodiment is described in detail.

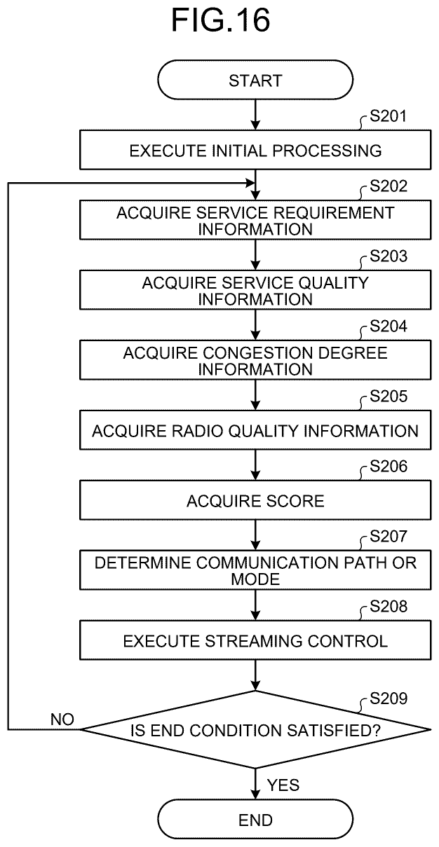

FIG. 16 is a flowchart illustrating communication control processing of the second embodiment. Note that, the following processing is assumed to be executed by a control unit 43 of the terminal device 40, but a part of or entire following processing may be executed by a control unit 13 of the server 10. A part of or entire following processing may be executed by a control unit 23 of a management device 20 or may be executed by a control unit 33 of a base station 30. Hereinafter, the communication control processing of the second embodiment is described with reference to the flowchart of FIG. 16.

When receiving an initialization instruction from a service (second entity), a communication control unit 435 of the terminal device 40 executes initial processing regarding a streaming service (step S201). An acquisition unit 431 of the terminal device 40 acquires service requirement information from the service (second entity) (step S202). Steps S201 and S202 are similar to steps S101 and S102 of the first embodiment.

Subsequently, the acquisition unit 431 of the terminal device 40 acquires information regarding the communication from each entity forming the communication system 1 (steps S203 to S205). Specifically, the acquisition unit 431 of the terminal device 40 acquires service requirement information for each communication path from the service (second entity) (step S203). The acquisition unit 431 of the terminal device 40 acquires congestion degree information for each communication path from a network (first entity) (step S204). The acquisition unit 431 of the terminal device 40 acquires radio quality information for each communication path (step S205). Steps S203 to S205 are similar to steps S103 to S105 of the first embodiment. Note that, the information regarding the communication acquired by the terminal device 40 may be a score or may remain as a parameter.

Note that, the information regarding communication acquired by the terminal device 40 from each entity may be time-series data (time-series parameters) at predetermined time intervals. For example, the information regarding the communication acquired by the terminal device 40 from each entity may be time-series data at one minute intervals (the service quality information, the congestion degree information, and the radio quality information). For example, if the time-series data is the congestion degree information, the terminal device 40 may acquire an occupancy rate and the number of connections of UE at one minute intervals from the network (first entity). At that time, in order to be able to estimate quality deterioration of the communication path with higher accuracy, the terminal device 40 may acquire a maximum value for the most recent one minute.

Next, the determination unit 432 of the terminal device 40 acquires the communication quality information (score) for each communication path on the basis of the information regarding the communication (service quality information, congestion degree information, and radio quality information) acquired at steps S203 to S205 (step S206). At that time, the terminal device 40 acquires the communication quality information (score) by inputting information regarding communication to the quality prediction model. In the following description, the score acquired at step S206 is sometimes referred to as a fourth score similarly to the first embodiment.

Next, the determination unit 432 of the terminal device 40 determines a content of communication control regarding the service on the basis of the score (fourth score) calculated at step S206 (step S207). The communication control unit 435 of the terminal device 40 executes communication control of the service (second entity) according to a determined content (step S208). Steps S207 and S208 are similar to steps S107 and S108 of the first embodiment.

Next, the terminal device 40 discriminates whether an end condition of the communication control processing is satisfied (step S209). In a case where the end condition is not satisfied (step S209: No), the terminal device 40 returns the processing to step S102. In a case where the end condition is satisfied (step S209: Yes), the terminal device 40 ends the communication control processing.

According to the present embodiment, since the communication system 1 predicts the quality of the communication path using the learning model, this can predict the quality of each of a plurality of communication paths with high accuracy. Since the communication system 1 controls the parameter regarding the communication quality on the basis of a prediction result, stable and high-quality streaming can be implemented.

### 3-5. Third Embodiment

Next, an operation of a communication system 1 of a third embodiment is described in detail.

In the third embodiment also, a terminal device 40 is configured to be able to perform communication using a plurality of communication paths simultaneously. In the first and second embodiments described above, the terminal device 40 determines the mode when the terminal device 40 performs simultaneous communication on the basis of the information regarding communication. In the third embodiment, in a case where it is determined that the terminal device 40 satisfies a predetermined criterion on the basis of information regarding the terminal device (for example, in a case where a remaining battery level of the terminal device 40 is equal to or less than a predetermined threshold), the terminal device 40 selects one or a plurality of communication paths to be used for communication by the terminal device 40 out of a plurality of communication paths. In a case where it is determined that the terminal device satisfies the predetermined criterion, the terminal device 40 performs communication using the selected communication path even in a case where a mode at the time of simultaneous communication is determined on the basis of the information regarding communication.

Note that, the information regarding the terminal device (hereinafter, referred to as terminal device information) may include at least one piece of information out of information on the remaining battery level of the terminal device 40, information on temperature of the terminal device 40, and information on uplink transmission power margin of the terminal device 40. Here, the uplink transmission power margin (P_{R}) may be a value calculated by following formula (3).

$${P}_{R} = P 1 - P 2 \qquad ( 3 )$$

Here, P1 is the maximum transmission power of the terminal device 40, and P2 is the transmission power necessary for data transmission. Note that, in a case where a reduction in maximum transmission power by specific absorption rate (SAR) backoff is specified, the specified reduction may be used for calculation of transmission power margin.

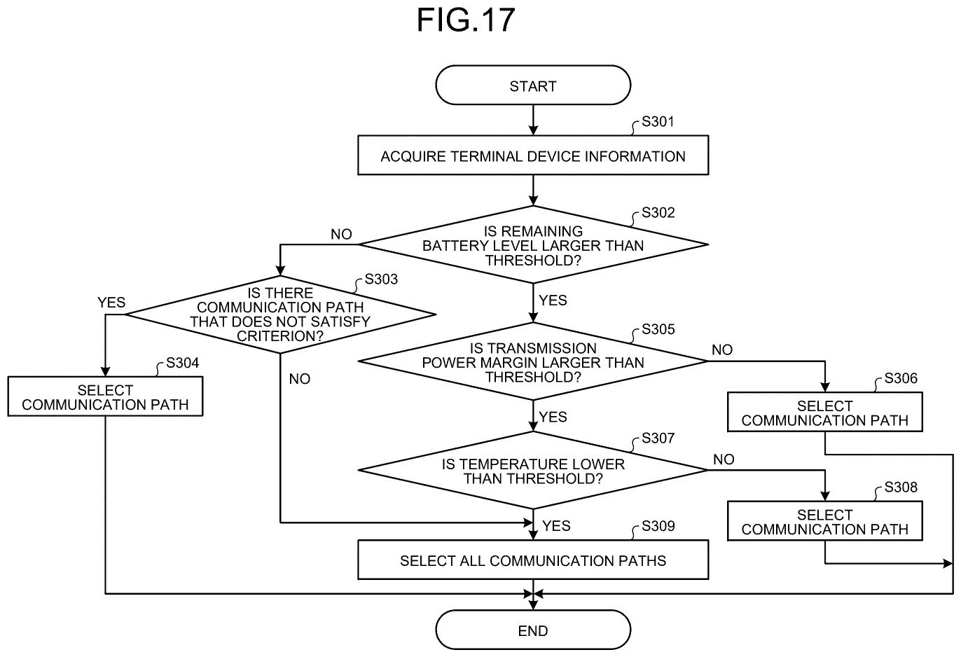

FIG. 17 is a flowchart illustrating communication path selection processing of the third embodiment. The following processing is executed, for example, in a case where it is determined in the communication control processing of the first and second embodiments that simultaneous communication using a plurality of communication paths is performed (for example, in a case where it is determined at step S107 or step S207 that redundant communication mode or high-speed communication mode is used). Note that, the following processing is assumed to be executed by a control unit 43 of the terminal device 40, but a part of or entire following processing may be executed by a control unit 13 of the server 10. A part of or entire following processing may be executed by a control unit 23 of a management device 20 or may be executed by a control unit 33 of a base station 30. Hereinafter, the communication path selection processing of the third embodiment is described with reference to the flowchart of FIG. 17.

An acquisition unit 431 of the terminal device 40 acquires the terminal device information (step S301). For example, the terminal device 40 acquires the information on the remaining battery level of the terminal device 40, the information on temperature of the terminal device 40, and the information on uplink transmission power margin of the terminal device 40.

Subsequently, a selection unit 433 of the terminal device 40 discriminates whether the remaining battery level is larger than a predetermined threshold (step S302). In a case where the remaining battery level is equal to or less than the predetermined threshold (step S302: No), the terminal device 40 discriminates whether there is a communication path communication quality of which does not satisfy a predetermined criterion among a plurality of communication paths (step S303). For example, the terminal device 40 discriminates whether there is the communication path a score of the communication quality of which (for example, the score acquired at step S107 of the first embodiment or step S207 of the second embodiment) is equal to or less than a predetermined threshold among a plurality of communication paths. In a case where all the communication paths satisfy the criterion (step S303: No), the processing proceeds to step S309.

A communication path with poor communication quality requires high transmission power, and it is also difficult to increase a transmission data rate. Therefore, even if simultaneous communication is performed in the redundant communication mode or the high-speed communication mode, an effect of using a plurality of communication paths cannot be expected much. Therefore, in a case where there is the communication path that does not satisfy the criterion (step S303: Yes), the selection unit 433 of the terminal device 40 selects the communication path communication quality of which satisfies the criterion out of a plurality of communication paths as the communication path to be used in the service (step S304). When the selection is completed, the terminal device 40 ends the communication path selection processing.

Returning to step S302, in a case where the remaining battery level is larger than the predetermined threshold (step S302: Yes), the selection unit 433 of the terminal device 40 discriminates whether a value of the transmission power margin is larger than a predetermined threshold (step S305).

In a case where the maximum transmission power of the terminal device 40 is determined, when the terminal device 40 uses a plurality of communication paths in a state in which there is not much transmission power margin and the maximum transmission power is exceeded, it is necessary to reduce the transmission power of each communication path. In this case, even if simultaneous communication is performed in the redundant communication mode or the high-speed communication mode, an effect of using a plurality of communication paths cannot be expected much. Therefore, in a case where the value of the transmission power margin is equal to or less than the predetermined threshold (step S305: No), the selection unit 433 of the terminal device 40 selects the communication path to be used in the service out of a plurality of communication paths so that the value of the transmission power margin becomes larger than the threshold (step S306). At that time, the terminal device 40 may reduce the communication paths to be used in ascending order of the score of the communication quality until the value of the transmission power margin becomes larger than the threshold. When the selection is completed, the terminal device 40 ends the communication path selection processing.

Returning to step S305, in a case where the value of the transmission power margin is larger than the predetermined threshold (step S305: Yes), the selection unit 433 of the terminal device 40 discriminates whether temperature of the terminal device 40 is lower than a predetermined threshold (step S307).

In a case where the temperature of the terminal device 40 is equal to or higher than a certain value, a reduction in communication frequency, suppression in transmission data rate, and stop of use of the communication path having a high contribution degree to an increase in temperature occur. In this case, even if simultaneous communication is performed in the redundant communication mode or the high-speed communication mode, an effect of using a plurality of communication paths cannot be expected much. Therefore, in a case where the temperature of the terminal device 40 is equal to or higher than the predetermined threshold (step S307: No), the selection unit 433 of the terminal device 40 selects the communication path to be used in the service out of a plurality of communication paths so that the temperature of the terminal device 40 becomes higher than the predetermined threshold (step S308).

For example, the terminal device 40 acquires information of a target temperature level. The terminal device 40 determines the number of available communication paths from the target temperature level. For example, it is assumed that current temperature of the terminal device 40 is T and thresholds are T1, T2, and T3. Assuming that T1>T2>T3, the terminal device 40 may set the number of available communication paths to one in a case where T≥T1 is satisfied, set the number of available communication paths to two in a case where T1>T>T2 is satisfied, set the number of available communication paths to three in a case where T2>T≥T3 is satisfied, and set the number of available communication paths to no upper limit in a case where T3>T. When the selection is completed, the terminal device 40 ends the communication path selection processing.

Returning to step S307, in a case where the temperature of the terminal device 40 is lower than the predetermined threshold (step S307: Yes), the selection unit 433 of the terminal device 40 selects all the communication paths as the communication path used in the service (step S309). When the selection is completed, the terminal device 40 ends the communication path selection processing.

According to the present embodiment, since the communication system 1 can change the communication method in accordance with the state of the terminal device 40, stable and high-quality streaming can be implemented.

### 4. Variations

The above-described embodiments are examples, and various modifications and applications are possible.

In the above-described embodiment (first and second embodiments), the terminal device 40 performs the communication control processing. However, a part of or entire communication control processing may be executed by a device other than the terminal device 40. For example, a server 10 may acquire information regarding communication (for example, at least one of service quality information, congestion degree information, and radio quality information) from each entity forming a communication system 1. The server 10 may determine a mode when the terminal device 40 performs simultaneous communication or a communication path used by the terminal device 40 for communication on the basis of the information regarding communication. At that time, the server 10 may transmit a determination result to the terminal device 40. The terminal device 40 may acquire the determination result from the server 10 and control communication of a service (second entity) on the basis of the determination result. It goes without saying that the server 10 may directly control the communication of the service (second entity).

The device that executes a part of or entire the communication control processing is not limited to the terminal device 40 and the server 10, and may be, for example, a management device 20 or a base station 30. At that time, the device may directly control the communication of the service (second entity), or may transmit the determination result to another device and control the communication of the service (second entity) via another device. At that time, another device is not limited to the terminal device 40 and the server 10, and may be, for example, the management device 20 or the base station 30.

In the above-described embodiment (third embodiment), the terminal device 40 performs the communication path selection processing. However, a part of or entire communication control processing may be executed by a device other than the terminal device 40. For example, the server 10 may acquire terminal device information from the terminal device 40. The server 10 may acquire the terminal device information from the base station 30 or the management device 20. In a case where it is determined that the terminal device 40 satisfies a predetermined criterion on the basis of the information regarding the terminal device, the server 10 may select one or a plurality of communication paths to be used for communication by the terminal device 40 out of a plurality of communication paths. At that time, the server 10 may transmit a selection result to the terminal device 40. The terminal device 40 may acquire the selection result from the server 10 and control the communication of the service (second entity) on the basis of the selection result. It goes without saying that the server 10 may directly control the communication of the service (second entity).

The device that executes a part of or entire the communication path selection processing is not limited to the terminal device 40 and the server 10, and may be, for example, the management device 20 or the base station 30. At that time, the device may directly control the communication of the service (second entity), or may transmit the selection result to another device and control the communication of the service (second entity) via another device. At that time, another device is not limited to the terminal device 40 and the server 10, and may be, for example, the management device 20 or the base station 30.

In the above-described embodiment (third embodiment), the terminal device 40 performs (a) selection of the communication path in a case where the remaining battery level is low (steps S302 to S304), (b) selection of the communication path in a case where the transmission power margin is low (steps S305 and S306), and (c) selection of the communication path in a case where temperature is high (steps S307 and S308). However, the terminal device 40 is not necessarily execute all of these pieces of processing. For example, the terminal device 40 may execute one or a plurality of pieces of processing selected from (a), (b), and (c). It goes without saying that the terminal device 40 can execute processing other than (a), (b), and (c). These pieces of processing may be executed by a device other than the terminal device 40.

In the above-described embodiment (third embodiment), the terminal device 40 executes the processing of (a), (b), and (c) on the basis of its own terminal device information. However, the terminal device information is not limited to its own information. For example, the terminal device 40 may execute at least one piece of processing of (a), (b), and (c) on the basis of terminal device information of another terminal device 40 (for example, a camera) connected to the terminal device 40 (for example, a smartphone).

In the above-described embodiment (first and second embodiments), the terminal device 40 or the server 10 collects the radio quality information, the congestion degree information, and the service quality information as the information regarding the communication from each entity forming the communication system 1. However, the information (information regarding communication) collected by the terminal device 40 or the server 10 is not necessarily all of these pieces of information. The information collected from each entity by the terminal device 40 or the server 10 may be one or a plurality of pieces of information selected from these pieces of information. It goes without saying that the terminal device 40 or the server 10 may collect information other than them as the information regarding the communication. These pieces of information may be collected by the device other than the terminal device 40 and the server 10 (for example, the management device 20 or the base station 30).

In the above-described embodiment, as a plurality of communication paths, communication paths of a plurality of cellular networks associated with different SIMs are exemplified. However, the plurality of communication paths is not limited to this example. For example, the plurality of communication paths may include a plurality of communication paths of different radio access technologies (RATs) provided by the same or different operators. For example, the plurality of communication paths may include a first communication path that connects the terminal device 40 and the server 10 via the cellular network of LTE and a second communication path that connects the terminal device 40 and the server 10 via the cellular network of NR. It goes without saying that the radio access technology is not limited to LTE and NR. The radio access technology may include, for example, Wi-Fi or Bluetooth (registered trademark).

In the above-described embodiment, the service provided by the second entity is the streaming service, but the service is not limited to the streaming service. For example, the service may be an upload or download service other than the streaming service.

In the above-described embodiment, as a plurality of modes selectable when the terminal device 40 performs the simultaneous communication, the redundant communication mode (first mode) and the high-speed communication mode (second mode) are illustrated. However, the plurality of modes is not limited thereto. The plurality of modes may include modes other than the redundant communication mode and the high-speed communication mode.

In the above-described embodiment, the redundant communication mode is a mode for improving communication reliability by transmitting the same packet to a plurality of communication paths. However, in the redundant communication mode, the packet may be transmitted by other transmission methods as long as the communication reliability is improved. For example, in the redundant communication mode, redundant data (error correction code) of a data amount equal to or larger than a predetermined threshold may be added.

In the above-described embodiment, the high-speed communication mode is a mode for improving throughput by transmitting the different packets to a plurality of communication paths. However, in the high-speed communication mode, the packet may be transmitted by other transmission methods as long as the throughput is improved. For example, in the high-speed communication mode, redundant data (error correction code) having a data amount equal to or less than a predetermined threshold may be added.

The control device that controls the server 10, the management device 20, the base station 30, or the terminal device 40 of the present embodiment may be implemented by a dedicated computer system or a general-purpose computer system.

For example, a communication program for executing the above-described operation is stored and distributed in a computer-readable recording medium such as an optical disk, a semiconductor memory, a magnetic tape, or a flexible disk. For example, the program is installed in a computer, and the above-described processing is executed to configure the control device. At that time, the control device may be a device (for example, a personal computer) outside the server 10, the management device 20, the base station 30, or the terminal device 40. The control device may be a device (for example, the control unit 13, the control unit 23, the control unit 33, or the control unit 43) inside the server 10, the management device 20, the base station 30, or the terminal device 40.

The above-described communication program may be stored in a disk device included in a server on a network such as the Internet so that the communication program can be downloaded to a computer. The above-described functions may be implemented by cooperation of an operating system (OS) and application software. In this case, a portion other than the OS may be stored in a medium and distributed, or a portion other than the OS may be stored in a server and downloaded to the computer.

Out of each processing described in the above-described embodiments, an entire or a part of the processing described as being performed automatically can be performed manually, or an entire or a part of the processing described as being performed manually can be performed automatically by a known method. The procedure, specific names, and information including various data and parameters described in the document and illustrated in the drawings can be optionally changed unless otherwise specified. For example, the various types of information illustrated in each drawing are not limited to the illustrated information.

Each component of each device illustrated in the drawings is functionally conceptual, and is not necessarily physically configured as illustrated in the drawings. That is, a specific form of distribution and integration of each device is not limited to the illustrated form, and an entire or a part thereof can be functionally or physically distributed and integrated in any unit according to various loads, usage conditions and the like. Note that, this distributed or integrated configuration may be performed dynamically.

The above-described embodiments can be appropriately combined within a range in which the processing contents do not contradict each other. The order of each step illustrated in the flowchart and the sequence diagram of the above-described embodiment can be changed as appropriate.

For example, the present embodiment can be implemented as any configuration forming a device or a system, for example, a processor as a system large scale integration (LSI) or the like, a module using a plurality of processors or the like, a unit using a plurality of modules or the like, a set obtained by further adding other functions to a unit or the like (that is, a configuration of a part of the device).

Note that, in the present embodiment, the system means a set of a plurality of components (devices, modules (parts) and the like), and it does not matter whether or not all the components are in the same housing. Therefore, a plurality of devices housed in separate housings and connected via a network and one device in which a plurality of modules is housed in one housing are both systems.

For example, the present embodiment can adopt a configuration of cloud computing in which one function is shared by a plurality of devices to process in cooperation via a network.

### 5. Conclusion

As described above, according to an embodiment of the present disclosure, the terminal device 40 is configured to be able to perform simultaneous communication using a plurality of communication paths associated with different SIMs simultaneously. The terminal device 40 performs the communication using the mode or the communication path determined on the basis of the information regarding the communication. At that time, the information regarding the communication includes information on the radio quality between the terminal device 40 and the base station 30 for each communication path, information on the congestion degree of the network for each communication path, and information on the service quality for each communication path. As a result, an optimum mode or communication path is selected, so that the terminal device 40 can implement stable and high-quality streaming.

Although the embodiments of the present disclosure are described above, the technical scope of the present disclosure is not limited to the above-described embodiments as it is, and various modifications can be made without departing from the gist of the present disclosure. The components of different embodiments and variation may be appropriately combined.

The effects described in each embodiment described in the present specification are merely examples and are not limited, and there may be other effects.

Note that, the present technology can also have the following configurations.

(1)

A terminal device capable of performing simultaneous communication simultaneously using a plurality of communication paths associated with different SIMs, respectively, the terminal device comprising:
a communication control unit that performs communication using a mode when the terminal device performs the simultaneous communication or one communication path out of the plurality of communication paths determined on a basis of information regarding the communication, wherein
the information regarding the communication includes information on radio quality between the terminal device and a base station for each of the communication paths, information on a congestion degree of a network for each of the communication paths, and information on service quality for each of the communication paths.
   (2)

The terminal device according to (1), comprising:
a determination unit that determines the mode when the terminal device performs the simultaneous communication or one communication path out of the plurality of communication paths on a basis of the information regarding the communication.
   (3)

The terminal device according to (1), comprising:
an acquisition unit that acquires, from another device that determines the mode when the terminal device performs the simultaneous communication or one communication path out of the plurality of communication paths used by the terminal device for the communication on a basis of the information regarding the communication, information determined by the another device, wherein
the communication control unit performs the communication using the mode or the one communication path determined by the another device.
   (4)

The terminal device according to (3), wherein
the another device is a server that provides a service to the terminal device.
   (5)

The terminal device according to any one of (1) to (4), wherein
the communication control unit performs the communication using the mode determined on a basis of the information regarding the communication.
   (6)

The terminal device according to (5), wherein
a plurality of modes selectable when the terminal device performs the simultaneous communication includes a first mode in which a same packet is transmitted to the plurality of communication paths and a second mode in which different packets are transmitted to the plurality of communication paths, and
the communication control unit performs the communication using a mode determined out of the plurality of modes on a basis of the information regarding the communication.
   (7)

The terminal device according to any one of (1) to (4), wherein
the communication control unit performs the communication using the one communication path determined on a basis of the information regarding the communication.
   (8)

The terminal device according to any one of (1) to (7), wherein
the information on radio quality between the terminal device and a base station for each of the communication paths includes information calculated by the terminal device for each of the communication paths on a basis of at least one piece of information out of reference signals received power (RSRP), reference signal received quality (RSRQ), and signal-to-noise ratio (SINR).
   (9)

The terminal device according to any one of (1) to (8), wherein
the information on a congestion degree of a network for each of the communication paths includes information on an occupation rate of a resource of the base station for each of the communication paths.
   (10)

The terminal device according to any one of (1) to (9), wherein
the information on a congestion degree of a network for each of the communication paths includes information on a number of connections of terminals to the base station for each of the communication paths.
   (11)

The terminal device according to any one of (1) to (10), wherein
the information on service quality for each of the communication paths includes information on service quality measured for each of the communication paths by the server that provides the service to the terminal device.
   (12)

The terminal device according to any one of (1) to (11), comprising:
a selection unit that selects one or a plurality of communication paths used by the terminal device for the communication out of the plurality of communication paths in a case where it is determined that the terminal device satisfies a predetermined criterion on a basis of information regarding the terminal device, wherein
in a case where it is determined that the terminal device satisfies the predetermined criterion, the communication control unit performs the communication using a selected communication path even in a case where the mode is determined on a basis of the information regarding the communication.
   (13)

The terminal device according to (12), wherein
the information regarding the terminal device includes at least one piece of information out of information on a remaining battery level of the terminal device, information on temperature of the terminal device, and information on uplink transmission power margin of the terminal device.
   (14)

An information processing device that communicates with a terminal device capable of performing simultaneous communication simultaneously using a plurality of communication paths associated with different SIMs, respectively, the information processing device comprising:
a determination unit that determines a mode when the terminal device performs the simultaneous communication or one communication path out of the plurality of communication paths used by the terminal device for communication on a basis of information regarding the communication; and
a transmission unit that transmits determined information to the terminal device, wherein
the information regarding the communication includes information on radio quality between the terminal device and a base station for each of the communication paths, information on a congestion degree of a network for each of the communication paths, and information on service quality for each of the communication paths.
   (15)

The information processing device according to (14), wherein
the determination unit determines the mode when the terminal device performs the simultaneous communication on a basis of the information regarding the communication.
   (16)

The information processing device according to (15), wherein
a plurality of modes selectable when the terminal device performs the simultaneous communication includes a first mode in which a same packet is transmitted to the plurality of communication paths and a second mode in which different packets are transmitted to the plurality of communication paths, and
the determination unit determines a mode when the terminal device performs the simultaneous communication out of the plurality of modes on a basis of the information regarding the communication.
   (17)

The information processing device according to (14), wherein
the determination unit determines one communication path used by the terminal device for the communication out of the plurality of communication paths on a basis of the information regarding the communication.
   (18)

The information processing device according to any one of (14) to (17), wherein
the information processing device is a server that provides a service to the terminal device.
   (19)

A communication method executed by a terminal device capable of performing simultaneous communication simultaneously using a plurality of communication paths associated with different SIMs, respectively, the communication method comprising:
a communication control step of performing communication using a mode when the terminal device performs the simultaneous communication or one communication path out of the plurality of communication paths determined on a basis of information regarding the communication, wherein
the information regarding the communication includes information on radio quality between the terminal device and a base station for each of the communication paths, information on a congestion degree of a network for each of the communication paths, and information on service quality for each of the communication paths.
   (20)

A communication method executed by an information processing device that communicates with a terminal device capable of performing simultaneous communication simultaneously using a plurality of communication paths associated with different SIMs, respectively, the communication method comprising:
a determination step of determining a mode when the terminal device performs the simultaneous communication or one communication path out of the plurality of communication paths used by the terminal device for communication on a basis of information regarding the communication; and
a transmission step of transmitting determined information to the terminal device, wherein
the information regarding the communication includes information on radio quality between the terminal device and a base station for each of the communication paths, information on a congestion degree of a network for each of the communication paths, and information on service quality for each of the communication paths.

### REFERENCE SIGNS LIST

1 COMMUNICATION SYSTEM
10 SERVER
20 MANAGEMENT DEVICE
30 BASE STATION
40 TERMINAL DEVICE
11, 21 COMMUNICATION UNIT
31, 41 RADIO COMMUNICATION UNIT
12, 22, 32, 42 STORAGE UNIT
13, 23, 33, 43 CONTROL UNIT
44 INPUT UNIT
45 OUTPUT UNIT
131, 431 ACQUISITION UNIT
132, 432 DETERMINATION UNIT
133, 433 SELECTION UNIT
134, 434 TRANSMISSION UNIT
135, 435 COMMUNICATION CONTROL UNIT
311, 411 TRANSMISSION PROCESSING UNIT
312, 412 RECEPTION PROCESSING UNIT
313, 413 ANTENNA
N1, N2 NETWORK

What is claimed is:

1. A terminal device capable of performing simultaneous communication simultaneously using a plurality of communication paths associated with different SIMs, respectively, the terminal device comprising:
a communication control unit that performs communication using a mode when the terminal device performs the simultaneous communication or one communication path out of the plurality of communication paths determined on a basis of information regarding the communication, wherein
the information regarding the communication includes information on radio quality between the terminal device and a base station for each of the communication paths, information on a congestion degree of a network for each of the communication paths, and information on service quality for each of the communication paths.

2. The terminal device according to claim 1, comprising:
a determination unit that determines the mode when the terminal device performs the simultaneous communication or one communication path out of the plurality of communication paths on a basis of the information regarding the communication.

3. The terminal device according to claim 1, comprising:
an acquisition unit that acquires, from another device that determines the mode when the terminal device performs the simultaneous communication or one communication path out of the plurality of communication paths used by the terminal device for the communication on a basis of the information regarding the communication, information determined by the another device, wherein
the communication control unit performs the communication using the mode or the one communication path determined by the another device.

4. The terminal device according to claim 3, wherein
the another device is a server that provides a service to the terminal device.

5. The terminal device according to claim 1, wherein
the communication control unit performs the communication using the mode determined on a basis of the information regarding the communication.

6. The terminal device according to claim 5, wherein
a plurality of modes selectable when the terminal device performs the simultaneous communication includes a first mode in which a same packet is transmitted to the plurality of communication paths and a second mode in which different packets are transmitted to the plurality of communication paths, and
the communication control unit performs the communication using a mode determined out of the plurality of modes on a basis of the information regarding the communication.

7. The terminal device according to claim 1, wherein
the communication control unit performs the communication using the one communication path determined on a basis of the information regarding the communication.

8. The terminal device according to claim 1, wherein
the information on radio quality between the terminal device and a base station for each of the communication paths includes information calculated by the terminal device for each of the communication paths on a basis of at least one piece of information out of reference signals received power (RSRP), reference signal received quality (RSRQ), and signal-to-noise ratio (SINR).

9. The terminal device according to claim 1, wherein
the information on a congestion degree of a network for each of the communication paths includes information on an occupation rate of a resource of the base station for each of the communication paths.

10. The terminal device according to claim 1, wherein
the information on a congestion degree of a network for each of the communication paths includes information on a number of connections of terminals to the base station for each of the communication paths.

11. The terminal device according to claim 1, wherein
the information on service quality for each of the communication paths includes information on service quality measured for each of the communication paths by the server that provides the service to the terminal device.

12. The terminal device according to claim 1, comprising:
a selection unit that selects one or a plurality of communication paths used by the terminal device for the communication out of the plurality of communication paths in a case where it is determined that the terminal device satisfies a predetermined criterion on a basis of information regarding the terminal device, wherein
in a case where it is determined that the terminal device satisfies the predetermined criterion, the communication control unit performs the communication using a selected communication path even in a case where the mode is determined on a basis of the information regarding the communication.

13. The terminal device according to claim 12, wherein
the information regarding the terminal device includes at least one piece of information out of information on a remaining battery level of the terminal device, information on temperature of the terminal device, and information on uplink transmission power margin of the terminal device.

14. An information processing device that communicates with a terminal device capable of performing simultaneous communication simultaneously using a plurality of communication paths associated with different SIMs, respectively, the information processing device comprising:
a determination unit that determines a mode when the terminal device performs the simultaneous communication or one communication path out of the plurality of communication paths used by the terminal device for communication on a basis of information regarding the communication; and
a transmission unit that transmits determined information to the terminal device, wherein
the information regarding the communication includes information on radio quality between the terminal device and a base station for each of the communication paths, information on a congestion degree of a network for each of the communication paths, and information on service quality for each of the communication paths.

15. The information processing device according to claim 14, wherein
the determination unit determines the mode when the terminal device performs the simultaneous communication on a basis of the information regarding the communication.

16. The information processing device according to claim 15, wherein
a plurality of modes selectable when the terminal device performs the simultaneous communication includes a first mode in which a same packet is transmitted to the plurality of communication paths and a second mode in which different packets are transmitted to the plurality of communication paths, and
the determination unit determines a mode when the terminal device performs the simultaneous communication out of the plurality of modes on a basis of the information regarding the communication.

17. The information processing device according to claim 14, wherein
the determination unit determines one communication path used by the terminal device for the communication out of the plurality of communication paths on a basis of the information regarding the communication.

18. The information processing device according to claim 14, wherein
the information processing device is a server that provides a service to the terminal device.

19. A communication method executed by a terminal device capable of performing simultaneous communication simultaneously using a plurality of communication paths associated with different SIMs, respectively, the communication method comprising:
a communication control step of performing communication using a mode when the terminal device performs the simultaneous communication or one communication path out of the plurality of communication paths determined on a basis of information regarding the communication, wherein
the information regarding the communication includes information on radio quality between the terminal device and a base station for each of the communication paths, information on a congestion degree of a network for each of the communication paths, and information on service quality for each of the communication paths.

20. A communication method executed by an information processing device that communicates with a terminal device capable of performing simultaneous communication simultaneously using a plurality of communication paths associated with different SIMs, respectively, the communication method comprising:
a determination step of determining a mode when the terminal device performs the simultaneous communication or one communication path out of the plurality of communication paths used by the terminal device for communication on a basis of information regarding the communication; and
a transmission step of transmitting determined information to the terminal device, wherein
the information regarding the communication includes information on radio quality between the terminal device and a base station for each of the communication paths, information on a congestion degree of a network for each of the communication paths, and information on service quality for each of the communication paths.
